(19) United States
(12) Patent Application Publication
(10) Pub. No.: US 2020/0219216 A1
(43) Pub. Date: Jul. 9, 2020

(54) A Digital Classroom With a Breakout Feature

(71) Applicant: WSE Hong Kong Limited, Hong Kong (CN)

(72) Inventors: Kenneth R. Davis, Barcelona (ES); Eric Friedman, Brookline, MA (US); Mohamed Asif, Tamilnadu (IN); Edoardo Giovanni Ferrara-Bardile, Barcelona (ES); Gemma Artieda Gutierrez, Barcelona (ES); Seth T. Ditchcreek, Valparaiso, IN (US)

(21) Appl. No.: 16/648,564

(22) PCT Filed: Sep. 19, 2018
(86) PCT No.: PCT/IB2018/057226

§ 371 Date: Mar. 18, 2020

Related U.S. Application Data
(60) Provisional application No. 62/560,416, filed on Sep. 19, 2017.

(51) Int. Cl. G06Q 50/20; G09B 5/06; H04L 29/06; H04N 21/44; H04N 21/439

(52) U.S. Cl. CPC G06Q 50/205; G09B 5/065; H04N 21/439; H04N 21/44; H04L 63/08

(57) ABSTRACT

The present invention allows a virtual online digital classroom to manage the audio and video streams of a teacher and students in a class. The teacher and students may start in a virtual “common room” where the teacher and students may all hear each other's audio and see each other's video streams. The teacher may move the students (and themselves) to two or more virtual breakout rooms. The teacher and/or students in a breakout room can only hear (and optionally only see) the teacher and/or the students in the same breakout room. In other words, the teacher and/or students in the breakout room cannot hear (and optionally cannot see) the teacher and/or students in the common room or in other breakout rooms. In preferred embodiments, the teacher may introduce different material to different breakout rooms and assess students during the breakout session.

CROSS-REFERENCE TO RELATED PATENT APPLICATIONS

This application claims priority to U.S. Application No. 62/560,416 titled “A Digital Classroom with a Breakout Feature” filed on Sep. 19, 2017 which is incorporated herein by reference in its entirety.

### FIELD OF THE INVENTION

This disclosure relates to the field an online digital classroom with an integrated breakout feature that creates virtual rooms with assessment tools.

### SUMMARY OF THE INVENTION

The present invention provides systems and methods comprising one or more server hardware computing devices or client hardware computing devices, communicatively coupled to a network (such as the Internet), and each comprising at least one processor executing specific computer-executable instructions within a memory that, when executed, cause the system to perform the following methods.

In an embodiment of the invention, a method is disclosed for using a digital classroom with one or more breakout rooms to teach a plurality of students a subject. As a non-limiting example, the students may be taught to read and write a language, such as English. However, the method may be used to teach any subject where breaking the students into smaller groups and allowing the smaller groups to interact amongst themselves would be advantageous.

A digital classroom may receive over the Internet a teacher video stream and a teacher audio stream from a teacher client device operated by a teacher. The digital classroom may also receive over the Internet a student video stream and a student audio stream from each student client device in a plurality of student client devices operated by a student in a plurality of students. It should be appreciated that the teacher and students may have already registered or signed up for a class and are preferably, after being authenticated, logged into the digital classroom. The number of students may be any desired number, but for teaching languages, is preferably no more than eight students.

The digital classroom may display on the teacher client device and the plurality of student client devices the teacher video stream in a teacher tile and the student video stream in a student tile for each student in the plurality of students. This allows the teacher and students to see in real-time the teacher and the students taking the class.

The digital classroom may communicate to the teacher client device and the plurality of student client devices the teacher audio stream from the teacher and the student audio stream from each student in the plurality of students. However, in a preferred embodiment, the teacher audio stream is not sent to the teacher client device and each student audio stream is preferably not sent to the student client device creating the student audio stream to prevent audio feedback. This allows the students to hear in real-time the teacher and the other students and the teacher to hear in real-time the other students taking the class. When the teacher and all the students can see and hear each other, they may be thought of as in a virtual common room or a common room.

At any time during the class, the teacher may decide to initiate a breakout or breakout session. The digital classroom may receive from the teacher client device a selection of a first two or more students in the plurality of students for a breakout in a first breakout room and a second two or more students in the plurality of students for the breakout in a second breakout room. Other students may be placed in other breakout rooms as desired. In preferred embodiments, all of the students are preferably placed into a breakout room and no student in the plurality of students is placed in more than one breakout room at a time.

Any student(s) not placed in a breakout room may remain in the default common room, possibly with the teacher. The teacher at any time may move any student(s) from the common room into any breakout room and/or any student(s) in a breakout room into any other breakout room or the common room. The teacher may also move themselves (the teacher) into any breakout room or the common room at any time during the breakout. The teacher may move the students and/or the teacher any number of desired times during the duration of the breakout. In a preferred embodiment, the teacher may select the teacher or one of the students, on the teacher client device, and drag and drop the teacher or the student (represented as a teacher (video) tile, student (video) tile, teacher icon or student icon) into one of the breakout rooms. It should be appreciated that the common room and breakout rooms are thus virtual rooms in the digital classroom defined by their functions, i.e., those that can hear each other are in the same breakout room.

In some embodiments, the digital classroom may receive a first selected subject matter from the teacher client device for the first breakout room. The digital classroom may also receive a second selected subject matter, different from the first selected subject matter, from the teacher client device for the second breakout room. This material may be presented on different virtual whiteboards in each breakout room. This allows the teacher to have students in different breakout rooms working on different material. Additional different selected subject matter may also be selected for other breakout rooms.

Thus, as a non-limiting example, the teacher may place the more advanced students together in a first breakout room to practice more advanced material and the teacher may place the less advanced students together in a second breakout room to practice less advanced material. As another option, the teacher may place the more talkative students together in one room and the less talkative students together in another room, so that the less talkative students have more of a chance to participate. The teacher may also separate students into different breakout rooms that appear to have a non-productive conflict with each other.

The digital classroom may receive from the teacher client device a selected duration of the breakout. The teacher may enter any desired duration time for the breakout or select a desired duration time from a dropdown menu. As non-limiting examples, the teacher may enter or the dropdown menu may contain the time periods of two minutes, five minutes, ten minutes or unlimited for the duration of the breakout. The breakout may automatically terminate after lasting the selected duration of the breakout. In some embodiments, the teacher may terminate a breakout early by selecting an option that immediately terminates the breakout. After a breakout has ended, either by timing out or by an early termination initiated by the teacher, all of the students may be automatically (without further action by the teacher or any student) moved back to the common room, i.e., the teacher and all of the students can hear and see each other.

To create a first breakout room, the digital classroom may disable the student audio stream of every student in the plurality of students not in the first breakout room to the first two or more students in the first breakout room for the duration of the breakout. To create a second breakout room, the digital classroom may disable the student audio stream of every student in the plurality of students not in the second breakout room to the second two or more students in the second breakout room for the duration of the breakout. This allows the students in the first breakout room to only hear each other (no student in the common room or another breakout room will hear from or be heard in the first breakout room) and allows the students in the second breakout room to only hear each other (no teacher or student in the common room or another breakout room will hear from or be heard in the second breakout room).

In some embodiments, the digital classroom may also disable the student video stream of every student in the plurality of students not in the first breakout room to the first two or more students in the first breakout room for the duration of the breakout. The digital classroom may also disable the student video stream of every student in the plurality of students not in the second breakout room to the second two or more students in the second breakout room for the duration of the breakout. This allows the students in the first breakout room to see only each other (no student in the common room or a different breakout room will see or be seen by those in the first breakout room) and allows the students in the second breakout room to only see each other (no students in the common room or a different breakout room will see or be seen by those in the second breakout room).

In some embodiments, the digital classroom may also allow the teacher to select (possibly via a drag and drop selection mechanism) the teacher to move to any of the breakout rooms or back to the common room at any time during the selected duration of the breakout. The teacher might also select a student tile or student icon to enter the breakout room of that student. This allows the teacher to move from breakout room to breakout room to answer questions, present subject matter and/or assess the students' abilities. In some embodiments, the teacher may have an option to be heard or not heard by all of the students, regardless of where the teacher and students are virtually located.

The teacher audio stream may be disabled for every student not in the same breakout room (or common room) as the teacher. Thus, only students in the common room can hear the teacher when the teacher is in the common room and only students in one of the breakout rooms can hear the teacher when the teacher is in the same breakout room.

In some embodiments, a real-time count down of the time remaining for the breakout may be displayed to the teacher client device and/or the student client devices so that the teacher and students may see in real time the remaining time of the breakout.

In some embodiments, the digital classroom may communicate to the teacher client device assessment criteria or rubric for a plurality of test areas while the teacher is in a breakout room. The teacher may assess one or more students in the breakout room as the teacher moves from breakout room to breakout room. The digital classroom may receive one or more assessment scores for the test areas from the teacher client device for students in the same breakout room as the teacher. Allowing the teacher to assess the students during a breakout is advantageous as it is easier for the teacher to clearly hear and identify the students in the same breakout room as the teacher as there are fewer students than when all of the students are in the common room.

In some embodiments, the digital classroom may display an indication on the teacher client device and the student client devices of which students are in the same or different breakout rooms. As one possible non-limiting example, the digital classroom may display a first colored icon on the student tile of every student and/or the teacher tile for every teacher in the first breakout room and a second colored icon, visually distinguishable from the first colored icon, on the student tile of every student and/or the teacher tile for every teacher in the second breakout room. In a similar manner, additional different visually distinguishable icons may be placed on the teacher tile and/or student tiles in other breakout rooms. This allows the teacher and students to easily see in which breakout room the teacher and students are located.

In some embodiments, the digital classroom stores the student audio stream and possibly the student video stream from each student in the plurality of students during the breakout into a gradebook stored in a data store/database. In other embodiments, the digital classroom stores the student audio stream and possibly the student video stream from each student in the plurality of students during the entire class into a gradebook stored in the data store/database.

The above features and advantages of the present invention will be better understood from the following detailed description taken in conjunction with the accompanying drawings.

### BRIEF DESCRIPTION OF THE DRAWINGS

FIGS. 1 and 2 illustrate block diagrams of a system that may be used to practice the invention.

FIGS. 3-11 illustrate non-limiting example screen shots for an example method of a student scheduling a class that may be displayed on a teacher client device and/or student client devices.

FIG. 12 illustrates a non-limiting example of a flowchart for an example method of scheduling classes using the present invention.

FIGS. 13-18 illustrate non-limiting example screen shots for an example method of using a whiteboard, sharing annotation privileges between teacher and students and displaying PowerPoint slides on the whiteboard that may be displayed on a teacher client device and/or student client devices.

FIG. 19 illustrates a non-limiting example of a flowchart of an example method of using and sharing a whiteboard in combination with other programs that display visual information, such as PowerPoint, and/or allows annotation on the whiteboard or on the PowerPoint slides.

FIGS. 20-30 illustrate non-limiting example screen shots for example methods of creating a breakout, breakout session or using a breakout feature of the invention that may be displayed on a teacher client device or student client devices.

FIG. 31 illustrates an example Control Flow Diagram for a Digital Classroom.

FIG. 32 illustrates an example Wall Street English™ (WSE) system architecture for practicing the invention.

FIG. 33 illustrates an example Data Flow Map for New Student Experience (NSE).

FIG. 34 illustrates an example the flow of material for a digital classroom.

FIGS. 35-37 are flowcharts of an example method of practicing the invention.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

Network

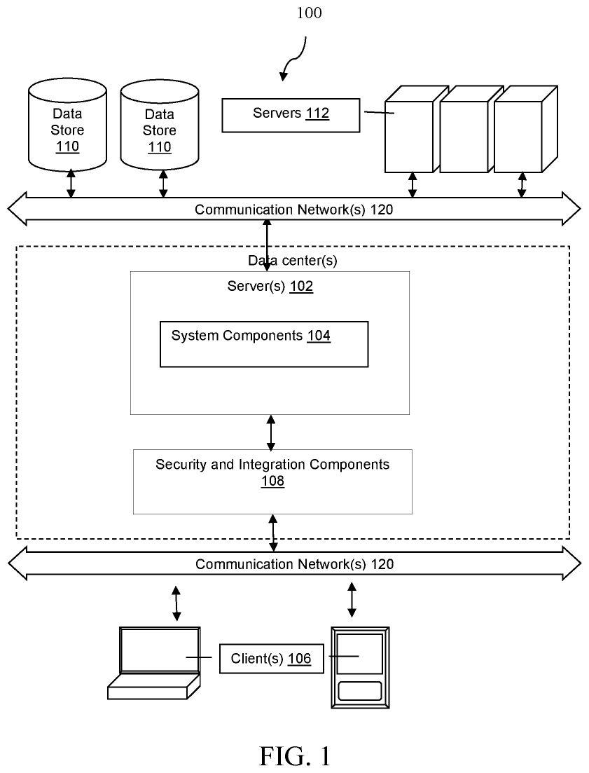

FIG. 1 illustrates a non-limiting example distributed computing environment 100, which includes one or more computer server computing devices 102, one or more client computing devices 106, and other components that may implement certain embodiments and features described herein. Other devices, such as specialized sensor devices, etc., may interact with client 106 and/or server 102. The server 102, client 106, or any other devices may be configured to implement a client-server model or any other distributed computing architecture.

Server 102, client 106, and any other disclosed devices may be communicatively coupled via one or more communication networks 120. Communication network 120 may be any type of network known in the art supporting data communications. As non-limiting examples, network 120 may be a local area network (LAN; e.g., Ethernet, Token-Ring, etc.), a wide-area network (e.g., the Internet), an infrared or wireless network, a public switched telephone networks (PSTNs), a virtual network, etc. Network 120 may use any available protocols, such as (e.g., transmission control protocol/Internet protocol (TCP/IP), systems network architecture (SNA), Internet packet exchange (IPX), Secure Sockets Layer (SSL), Transport Layer Security (TLS), Hypertext Transfer Protocol (HTTP), Secure Hypertext Transfer Protocol (HTTPS), Institute of Electrical and Electronics (IEEE) 802.11 protocol suite or other wireless protocols, and the like.

Servers/Clients

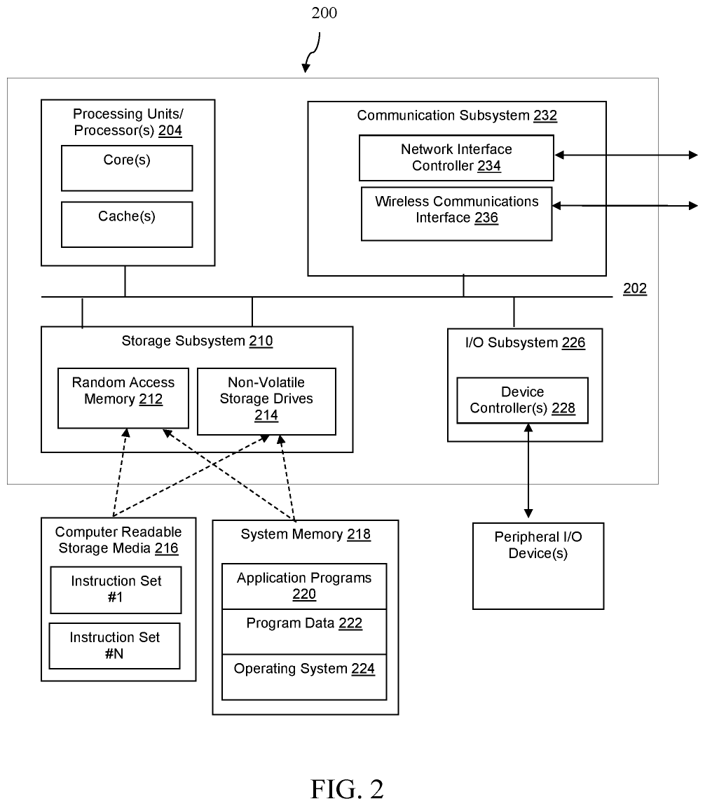

The embodiments shown in FIGS. 1-2 are thus one example of a distributed computing system and is not intended to be limiting. The subsystems and components within the server 102 and client devices 106 may be implemented in hardware, firmware, software, or combinations thereof. Various different subsystems and/or components 104 may be implemented on server 102. Users operating the client devices 106 may initiate one or more client applications to use services provided by these subsystems and components. Various different system configurations are possible in different distributed computing systems 100 and content distribution networks. Server 102 may be configured to run one or more server software applications or services, for example, web-based or cloud-based services, to support content distribution and interaction with client devices 106. Users operating client devices 106 may in turn utilize one or more client applications (e.g., virtual client applications) to interact with server 102 to utilize the services provided by these components. Client devices 106 may be configured to receive and execute client applications over one or more networks 120. Such client applications may be web browser based applications and/or standalone software applications, such as mobile device applications. Client devices 106 may receive client applications from server 102 or from other application providers (e.g., public or private application stores).

Security

As shown in FIG. 1, various security and integration components 108 may be used to manage communications over network 120 (e.g., a file-based integration scheme or a service-based integration scheme). Security and integration components 108 may implement various security features for data transmission and storage, such as authenticating users or restricting access to unknown or unauthorized users,

As non-limiting examples, these security components 108 may comprise dedicated hardware, specialized networking components, and/or software (e.g., web servers, authentication servers, firewalls, routers, gateways, load balancers, etc.) within one or more data centers in one or more physical location and/or operated by one or more entities, and/or may be operated within a cloud infrastructure.

In various implementations, security and integration components 108 may transmit data between the various devices in the content distribution network 100. Security and integration components 108 also may use secure data transmission protocols and/or encryption (e.g., File Transfer Protocol (FTP), Secure File Transfer Protocol (SFTP), and/or Pretty Good Privacy (PGP) encryption) for data transfers, etc.).

In some embodiments, the security and integration components 108 may implement one or more web services (e.g., cross-domain and/or cross-platform web services) within the content distribution network 100, and may be developed for enterprise use in accordance with various web service standards (e.g., the Web Service Interoperability (WS-I) guidelines). For example, some web services may provide secure connections, authentication, and/or confidentiality throughout the network using technologies such as SSL, TLS, HTTP, HTTPS, WS-Security standard (providing secure SOAP messages using XML encryption), etc. In other examples, the security and integration components 108 may include specialized hardware, network appliances, and the like (e.g., hardware-accelerated SSL and HTTPS), possibly installed and configured between servers 102 and other network components, for providing secure web services, thereby allowing any external devices to communicate directly with the specialized hardware, network appliances, etc.

Data Stores (Databases)

Computing environment 100 also may include one or more data stores 110, possibly including and/or residing on one or more back-end servers 112, operating in one or more data centers in one or more physical locations, and communicating with one or more other devices within one or more networks 120. In some cases, one or more data stores 110 may reside on a non-transitory storage medium within the server 102. In certain embodiments, data stores 110 and back-end servers 112 may reside in a storage-area network (SAN). Access to the data stores may be limited or denied based on the processes, user credentials, and/or devices attempting to interact with the data store.

Computer System

With reference now to FIG. 2, a block diagram of an illustrative computer system is shown. The system 200 may correspond to any of the computing devices or servers of the network 100, or any other computing devices described herein. In this example, computer system 200 includes processing units 204 that communicate with a number of peripheral subsystems via a bus subsystem 202. These peripheral subsystems include, for example, a storage subsystem 210, an I/O subsystem 226, and a communications subsystem 232.

Processors

One or more processing units 204 may be implemented as one or more integrated circuits (e.g., a conventional micro-processor or microcontroller), and controls the operation of computer system 200. These processors may include single core and/or multicore (e.g., quad core, hexa-core, octo-core, ten-core, etc.) processors and processor caches. These processors 204 may execute a variety of resident software processes embodied in program code, and may maintain multiple concurrently executing programs or processes. Processor(s) 204 may also include one or more specialized processors, (e.g., digital signal processors (DSPs), outboard, graphics application-specific, and/or other processors).

Buses

Bus subsystem 202 provides a mechanism for intended communication between the various components and subsystems of computer system 200. Although bus subsystem 202 is shown schematically as a single bus, alternative embodiments of the bus subsystem may utilize multiple buses. Bus subsystem 202 may include a memory bus, memory controller, peripheral bus, and/or local bus using any of a variety of bus architectures (e.g. Industry Standard Architecture (ISA), Micro Channel Architecture (MCA), Enhanced ISA (EISA), Video Electronics Standards Association (VESA), and/or Peripheral Component Interconnect (PCI) bus, possibly implemented as a Mezzanine bus manufactured to the IEEE P1386.1 standard).

Input/Output

I/O subsystem 226 may include device controllers 228 for one or more user interface input devices and/or user interface output devices, possibly integrated with the computer system 200 (e.g., integrated audio/video systems, and/or touchscreen displays), or may be separate peripheral devices which are attachable/detachable from the computer system 200. Input may include keyboard or mouse input, audio input (e.g., spoken commands), motion sensing, gesture recognition (e.g., eye gestures), etc.

Input

As non-limiting examples, input devices may include a keyboard, pointing devices (e.g., mouse, trackball, and associated input), touchpads, touch screens, scroll wheels, click wheels, dials, buttons, switches, keypad, audio input devices, voice command recognition systems, microphones, three dimensional (3D) mice, joysticks, pointing sticks, gamepads, graphic tablets, speakers, digital cameras, digital camcorders, portable media players, webcams, image scanners, fingerprint scanners, barcode readers, 3D scanners, 3D printers, laser rangefinders, eye gaze tracking devices, medical imaging input devices, MIDI keyboards, digital musical instruments, and the like.

Output

In general, use of the term “output device” is intended to include all possible types of devices and mechanisms for outputting information from computer system 200 to a user or other computer. For example, output devices may include one or more display subsystems and/or display devices that visually convey text, graphics and audio/video information (e.g., cathode ray tube (CRT) displays, flat-panel devices, liquid crystal display (LCD) or plasma display devices, projection devices, touch screens, etc.), and/or non-visual displays such as audio output devices, etc. As non-limiting examples, output devices may include, indicator lights, monitors, printers, speakers, headphones, automotive navigation systems, plotters, voice output devices, modems, etc.

Memory or Storage Media

Computer system 200 may comprise one or more storage subsystems 210, comprising hardware and software components used for storing data and program instructions, such as system memory 218 and computer-readable storage media 216.

System memory 218 and/or computer-readable storage media 216 may store program instructions that are loadable and executable on processor(s) 204. For example, system memory 218 may load and execute an operating system 224, program data 222, server applications, client applications 220, Internet browsers, mid-tier applications, etc.

System memory 218 may further store data generated during execution of these instructions. System memory 218 may be stored in volatile memory (e.g., random access memory (RAM) 212, including static random access memory (SRAM) or dynamic random access memory (DRAM)). RAM 212 may contain data and/or program modules that are immediately accessible to and/or operated and executed by processing units 204.

System memory 218 may also be stored in non-volatile storage drives 214 (e.g., read-only memory (ROM), flash memory, etc.) For example, a basic input/output system (BIOS), containing the basic routines that help to transfer information between elements within computer system 200 (e.g., during start-up) may typically be stored in the non-volatile storage drives 214.

Computer Readable Storage Media

Storage subsystem 210 also may include one or more tangible computer-readable storage media 216 for storing the basic programming and data constructs that provide the functionality of some embodiments. For example, storage subsystem 210 may include software, programs, code modules, instructions, etc., that may be executed by a processor 204, in order to provide the functionality described herein. Data generated from the executed software, programs, code, modules, or instructions may be stored within a data storage repository within storage subsystem 210.

Storage subsystem 210 may also include a computer-readable storage media reader connected to computer-readable storage media 216. Computer-readable storage media 216 may contain program code, or portions of program code. Together and, optionally, in combination with system memory 218, computer-readable storage media 216 may comprehensively represent remote, local, fixed, and/or removable storage devices plus storage media for temporarily and/or more permanently containing, storing, transmitting, and retrieving computer-readable information.

Computer-readable storage media 216 may include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computer system 200.

By way of example, computer-readable storage media 216 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 216 may include, but is not limited to, Zip® drives, flash memory cards, universal serial bus (USB) flash drives, secure digital (SD) cards, DVD disks, digital video tape, and the like. Computer-readable storage media 216 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magneto-resistive RAM (MRAM) SSDs, and hybrid SSDs that use a combination of DRAM and flash memory based SSDs. The disk drives and their associated computer-readable media may provide non-volatile storage of computer-readable instructions, data structures, program modules, and other data for computer system 200.

Communication Interface

Communications subsystem 232 may provide a communication interface from computer system 200 and external computing devices via one or more communication networks, including local area networks (LANs), wide area networks (WANs) (e.g., the Internet), and various wireless telecommunications networks. As illustrated in FIG. 2, the communications subsystem 232 may include, for example, one or more network interface controllers (NICs) 234, such as Ethernet cards, Asynchronous Transfer Mode NICs, Token Ring NICs, and the like, as well as one or more wireless communications interfaces 236, such as wireless network interface controllers (WNICs), wireless network adapters, and the like. Additionally and/or alternatively, the communications subsystem 232 may include one or more modems (telephone, satellite, cable, ISDN), synchronous or asynchronous digital subscriber line (DSL) units, Fire Wire® interfaces, USB® interfaces, and the like. Communications subsystem 236 also may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components.

Input Output Streams Etc.

In some embodiments, communications subsystem 232 may also receive input communication in the form of structured and/or unstructured data feeds, event streams, event updates, and the like, on behalf of one or more users who may use or access computer system 200. For example, communications subsystem 232 may be configured to receive data feeds in real-time from users of social networks and/or other communication services, web feeds such as Rich Site Summary (RSS) feeds, and/or real-time updates from one or more third party information sources (e.g., data aggregators). Additionally, communications subsystem 232 may be configured to receive data in the form of continuous data streams, which may include event streams of real-time events and/or event updates (e.g., sensor data applications, financial tickers, network performance measuring tools, clickstream analysis tools, automobile traffic monitoring, etc.). Communications subsystem 232 may output such structured and/or unstructured data feeds, event streams, event updates, and the like to one or more data stores that may be in communication with one or more streaming data source computers coupled to computer system 200.

Connect Components to System

The various physical components of the communications subsystem 232 may be detachable components coupled to the computer system 200 via a computer network, a FireWire® bus, or the like, and/or may be physically integrated onto a motherboard of the computer system 200. Communications subsystem 232 also may be implemented in whole or in part by software.

Other Variations

Due to the ever-changing nature of computers and networks, the description of computer system 200 depicted in the figure is intended only as a specific example. Many other configurations having more or fewer components than the system depicted in the figure are possible. For example, customized hardware might also be used and/or particular elements might be implemented in hardware, firmware, software, or a combination. Further, connection to other computing devices, such as network input/output devices, may be employed. Based on the disclosure and teachings provided herein, a person of ordinary skill in the art will appreciate other ways and/or methods to implement the various embodiments.

In one embodiment of the invention, students may physically travel to a center or training facility to study and prepare for future classes. After preparing at the center or training facility, students may take online courses that reinforces the studied materials and also allows a teacher to access the students' progress.

In another embodiment of the invention, students may study and prepare for future classes by accessing a digital classroom via the Internet. The students may use client devices 106 with operating systems and a browser. In a preferred embodiment, the students do not need to download any applications specific for the classes in the digital classroom, as each student's operating system, browser and a virtual digital classroom's website have the necessary computer software. Not having to download any special software, possibly from a different website, greatly simplifies the process for the students to access the online classes. The student client devices and the teacher client device may be configured the same as the client device(s) 106 as described in FIGS. 1 and 2 (hereafter referred to as the teacher client device 106 or the student client devices 106). The teacher client device 106 may be operated by a teacher and each student client device 106 may be operated by at least one student in a plurality of students taking the class.

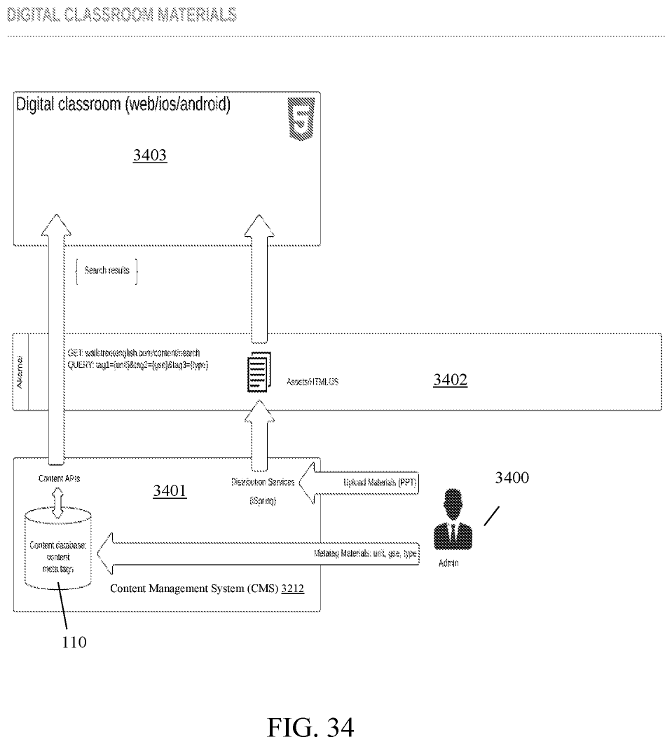

An administrator 3400 (school employee, such as a content editor or content creator) for the virtual digital classroom may store digital classroom material for each type of class in an online data store 110 or database as shown in FIG. 34. The digital classroom material and the class that will use the digital classroom material may be linked by one or more shared numbers, such as level, unit, type or an identification number for class. The administrator 3400 may also upload materials, such as PowerPoint (PPT), to the data store 110 for use during the class.

The online digital classroom, i.e., school, may schedule classes using any desired method. In one method, the school may determine which classes to offer, the distribution of the classes across the week, the hours the classes are to take place and the level of the classes based on the student population and the level distribution and historic attendance activity of the students and automatically determine the quantity of each class type to be scheduled as well as the optimal day of the week and time of day for each class.

In another embodiment of scheduling classes, the school may automatically assign teachers to the scheduled classes based on the teachers' availability and skill set and the class types and courses the teachers are trained to teach.

In another embodiment of scheduling classes, the school may match student availability and readiness with the scheduled classes. The school may gather student preferences and based on the students' historic study trends, automatically group students together for their upcoming classes based on study rhythm, unit and preferred attendance time in order to optimize class usage.

In another embodiment of scheduling classes, the school may use an on demand method to match students with teachers. This allows VIP students to request a class, identify available teachers with a suitable skillset to teach the class and automatically schedule the class for the teacher and the student.

In another embodiment of scheduling classes, the online digital classroom may determine the number, skill level and availability of their teachers and the number and skill level of their students and past class attendance from past class offerings. Teachers may enter their availability into the system. The system may track the current active students in determining which classes are likely to be needed by each student. The system may automatically make available an optimum number of classes offered by the school based on these known factors of their students and teachers.

In another embodiment of scheduling classes, a first student may sign up for a class and the class then assumes the skill level of the first student. Other students of the same or similar skill level may also sign up for the class along with the first student after the first student has started the class by signing up for the class. The class may continue to grow in this manner until a maximum number of students for the class have signed up/scheduled/registered for the class. In this manner classes may start and grow based on the level and/or needs of the students.

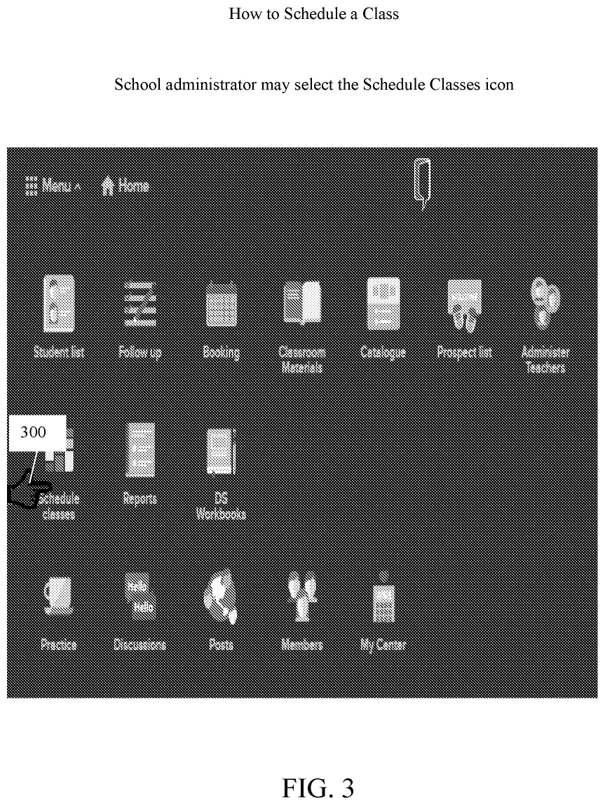

FIGS. 3-11, 13-18 and 20-30 illustrate non-limiting example screen shots for an example method for practicing the invention. It should be appreciated that each screenshot may be a webpage or a display created by an application program. A digital classroom may display the screenshots (or similar recreations) on the teacher client device 106 and/or the student client devices 106. It should be appreciated that certain screenshots may be displayed only to the teacher, other screenshots may be displayed only to the students and yet other screenshots may be displayed to both the teacher and the students. The software to run the system and the data needed to display the screenshots may be stored on one or more hardware servers that form part of the digital classroom.

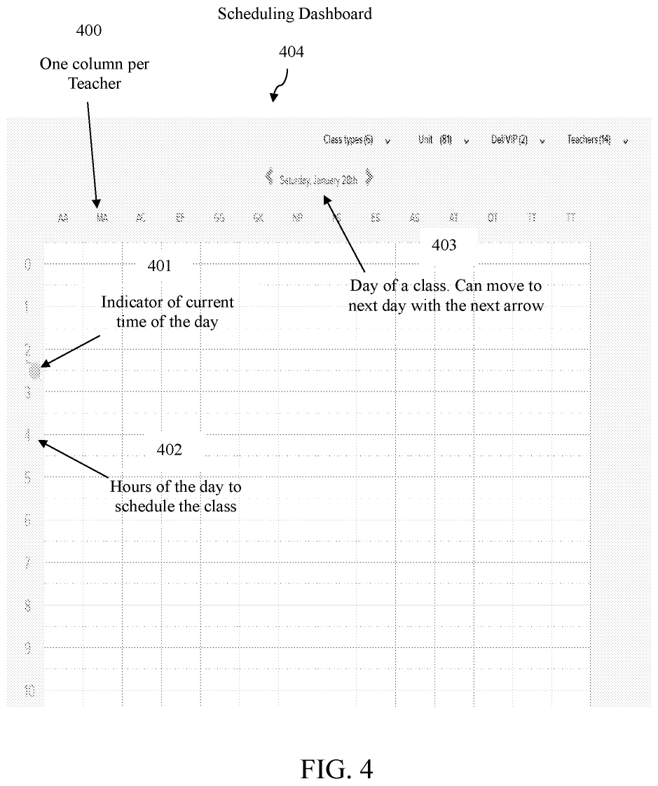

Referring to FIG. 3, the digital classroom may display to a school administrator client device the illustrated screenshot. The school administrator (such as a service manager or limited service manager) from the school administrator client device 106 may select a “Schedule Classes” icon 300 as illustrated in the screenshot. After the school administrator selects the “Schedule Classes” icon 300, the school administrator may access a Scheduling Dashboard to select a class as illustrated in FIG. 4.

An example Scheduling Dashboard 404 is illustrated in FIG. 4. The Scheduling Dashboard 404 is illustrated as a table or grid with a displayed date of the classes 403, a plurality of teachers 400, where each teacher is associated with a column in the table and a plurality of hours, where each hour is associated with a row in the table 402. In this example screenshot, an indicator of the current time of day is illustrated with a dot 401. Other layouts for the dashboard may also be used, such as the rows representing teachers and the columns representing hours for the classes. The data for the teachers available on the displayed date and the teachers' available hours on the date may be stored in data store 110 and read by the digital classroom in creating and displaying the Scheduling Dashboard 404. It should be appreciated that any method of allowing a school administrator to select a class from a plurality of classes may be used instead of this specific example embodiment.

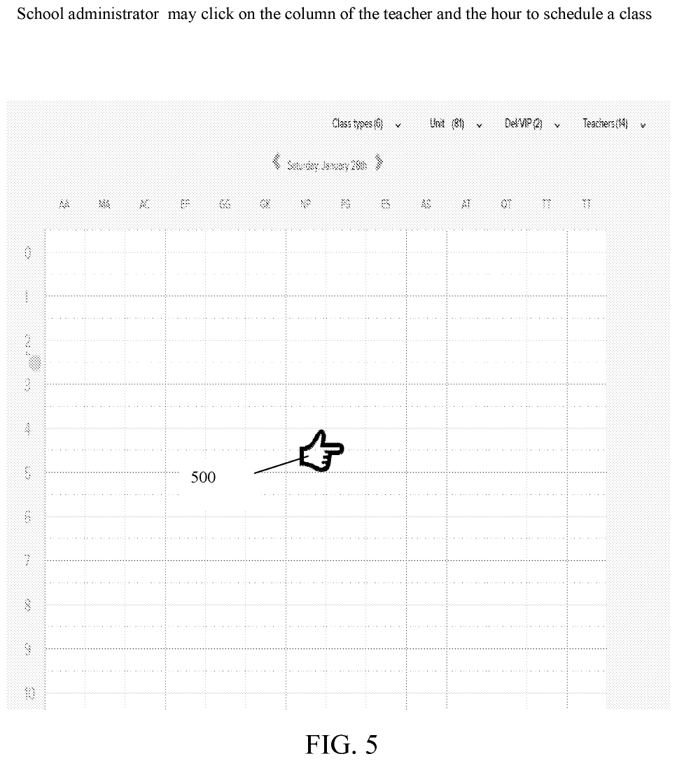

As a specific example, FIG. 5 illustrates a curser 500 controlled by a school administrator clicking on a column of a teacher and a row having a desired hour/time to schedule a class. In this illustrated example, the school administrator selected teacher PS and a class at 4:30 on Saturday, January 28th. The data regarding the selected class may be stored in the data store 110 for later reference and use in building the class by the digital classroom.

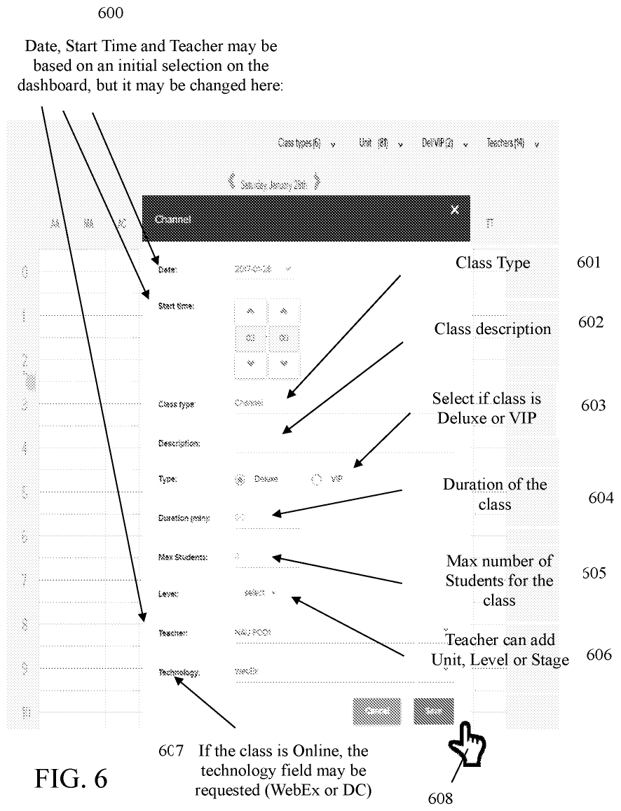

FIG. 6 is a non-limiting example of a screenshot that displays details regarding the selected class by the school administrator and allows the school administrator to enter or change some of the details of the class. In this example screenshot, the school administrator is displayed (and for some items may have the option to change) the date, start time and the teacher 600 for the selected class, the class type 601, the class description 602, whether the class is Deluxe or VIP 603, the duration of the selected class 604, the maximum number of students for the class 605, unit, level and/or stage if needed for the class 606 and the technology options available for attending the class 607. Once the school administrator has confirmed and/or entered the requested data, the school administrator may select the “Save” command using icon 608. The data entered by the school administrator in FIG. 6 in scheduling the class, may be stored in the data store 110 and used by the digital classroom in scheduling the class.

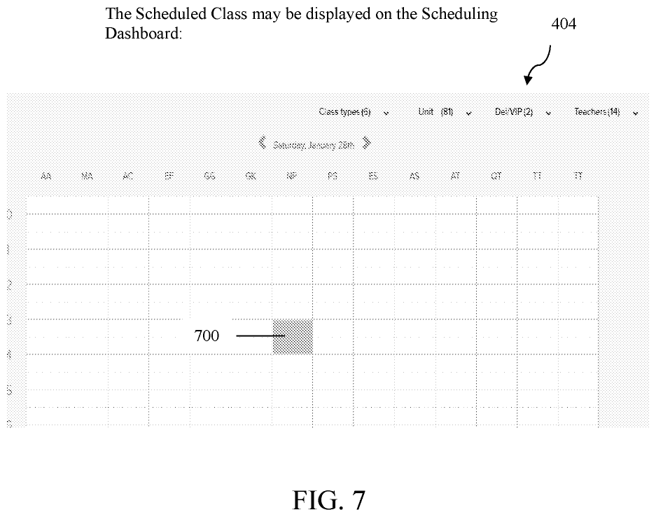

FIG. 7 is an example screenshot that illustrates a class schedule displayed on the Scheduling Dashboard 404 to the client device of a school administrator. In this example in FIG. 7, the school or Digital Classroom only has one scheduled class 700. The Digital Classroom may read data regarding the school's schedule from the data store 110 in creating the updated Scheduling Dashboard 404.

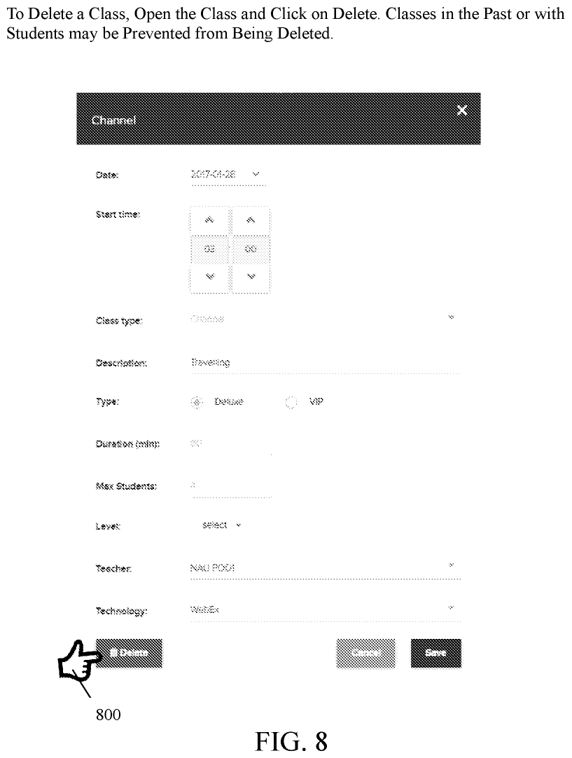

FIG. 8 illustrates an example screenshot of a school administrator deleting a class. The school administrator may select a class from the Scheduling Dashboard 404 and then select the delete option 800 illustrated in FIG. 8. In preferred embodiments, classes in the past cannot be deleted. Once the school administrator selects the delete option 800, the class is deleted and the scheduling data stored in the data store 110 is updated. The Scheduling Dashboard 404 will no longer show the deleted class.

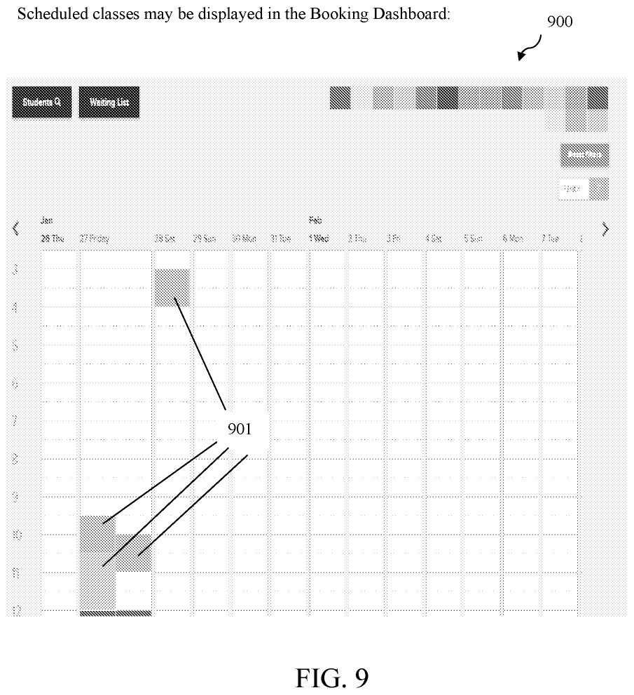

FIG. 9 illustrates an example screenshot of a Booking Dashboard 900. In this example, the Booking Dashboard 900 illustrates the scheduled classes 901 for the school or Digital Classroom. In this example, the school or Digital Classroom has scheduled three classes on Friday and one class on Saturday 901 for students to book.

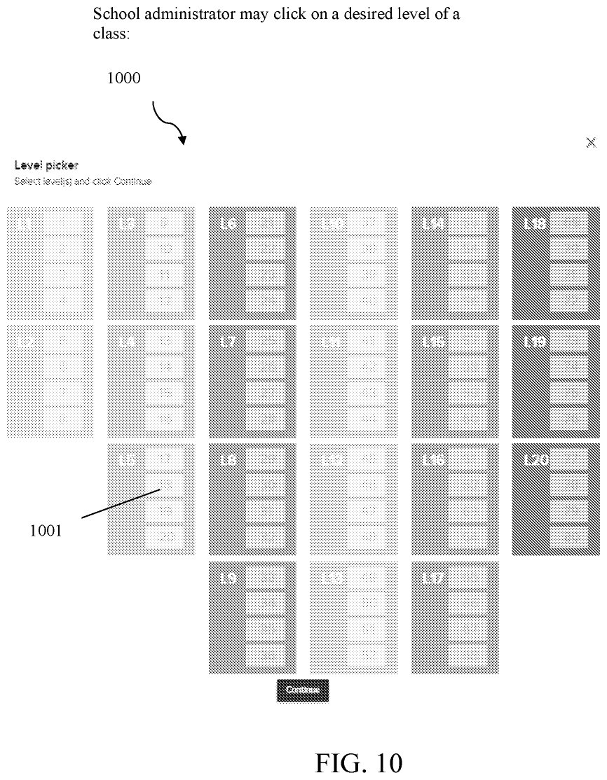

FIG. 10 illustrates a screenshot of a level picker 100 that may be used by a school administrator to select a level of a class. The school administrator may click on and select the level to assist the school administrator in scheduling a class of the appropriate level. In the illustrated example, the school administrator selected L5 18 as the desired level of the class the school administrator would like to schedule. Class levels may be represented on any desired scale.

The school or digital classroom may also include a waiting list function. The waiting list function may receive from a school administrator one or more classes that have been requested by students. The waiting list function may store and list the desired classes to assist a school administrator in scheduling these additional desired classes of the students.

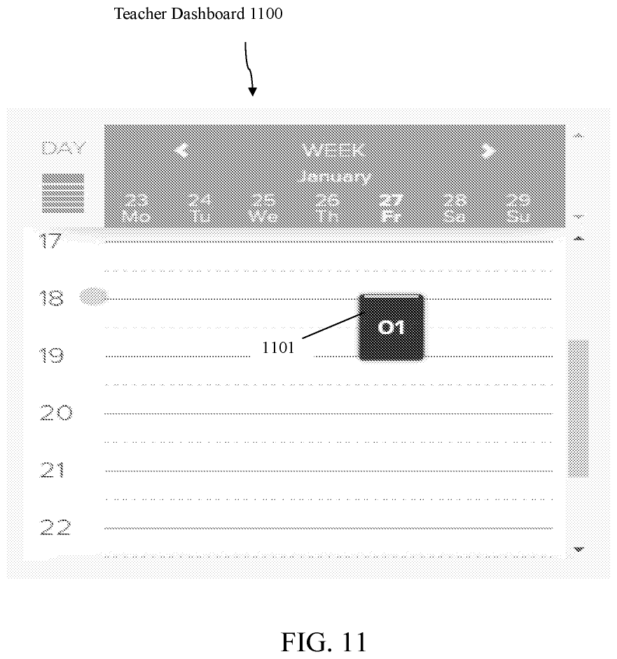

FIG. 11 illustrates an example Teacher Dashboard 1100 that may be used by a teacher to determine which class(es) the teacher is assigned to teach. In this example, the teacher is assigned to teach a class on January 27 (Friday) from 18:00 to 19:00. The icon 1101 on the Teacher Dashboard 1100 may be used to indicate the level or which class type the teacher is scheduled to teach. The data used to create the Teacher Dashboard 1100 may be stored in data store 110.

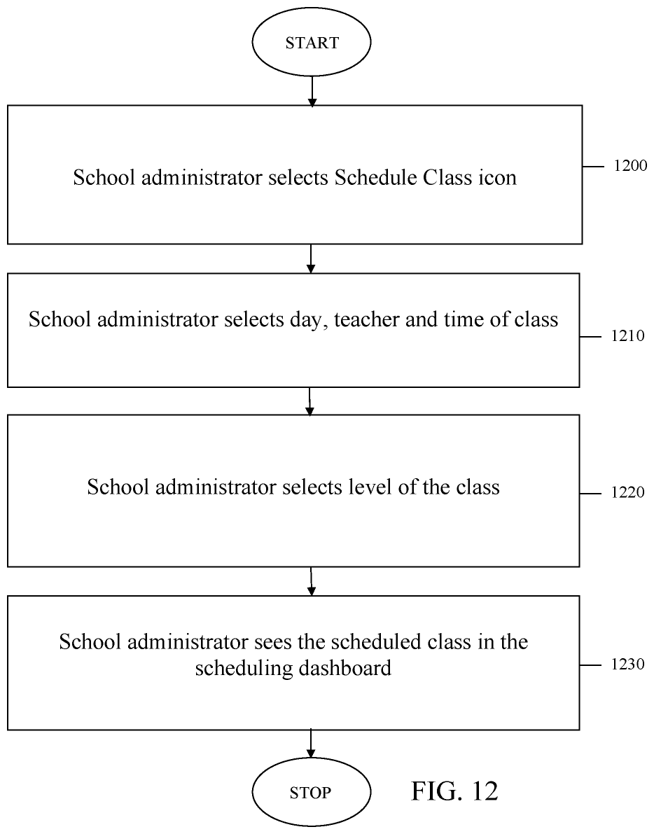

FIG. 12 is a non-limiting flowchart of a method for a school administrator to schedule a class as described in FIGS. 3-11 so that students may book themselves into the scheduled classes. The school administrator may select a Schedule Class icon 300 from a screen displayed on the school administrator client device 106. (Step 1200) The digital classroom may present a Scheduling Dashboard 404 to the school administrator where the school administrator may be able to select a day, a teacher and a time of a class in order to schedule the class. (Step 1201) The school administrator may select a level of the class on the same screen or on a different screen, such as the level picker illustrated in FIG. 10. (Step 1202) After scheduling the class, the school administrator may see the class on the Scheduling Dashboard 404. (Step 1203) At a time before the class, the school administrator may delete the class as shown in FIG. 8.

The teacher client device 106 and student client devices 106 may download digital classroom materials for the class from an online data store 110 prior to the start of the class as illustrated in FIG. 34. The teacher client device 106 and student client devices 106 may also download materials, such as PowerPoint files, from a distribution service.

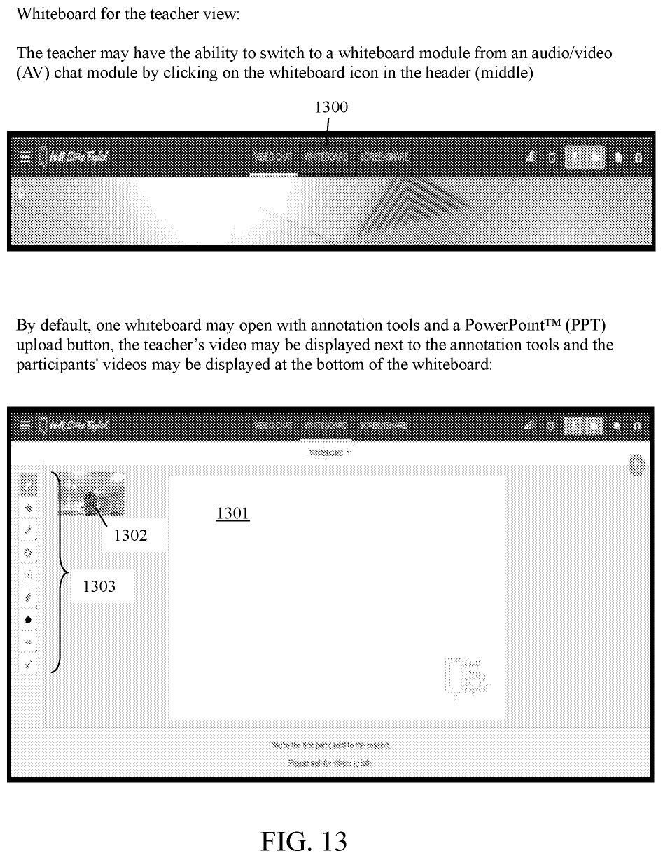

FIG. 13 illustrates an example screenshot that may be displayed by the digital classroom on the teacher client device 106. The teacher may select a “WHITEBOARD” option 1300 to enable the whiteboard 1301 at any time during the class. In a preferred embodiment, the teacher may have the ability to switch to a whiteboard module from an AV chat module by clicking on the whiteboard icon 1300 in the header (middle). By default, one whiteboard 1301 may open with annotation tools 1303 and a PPT upload button. The teacher video 1302 may be displayed next to the annotation tools 1303 and the student videos or student tiles may be displayed at the bottom of the whiteboard. The teacher at the beginning of the class may have access to the whiteboard 1301 and control (on/off) over the video and/or audio of the students.

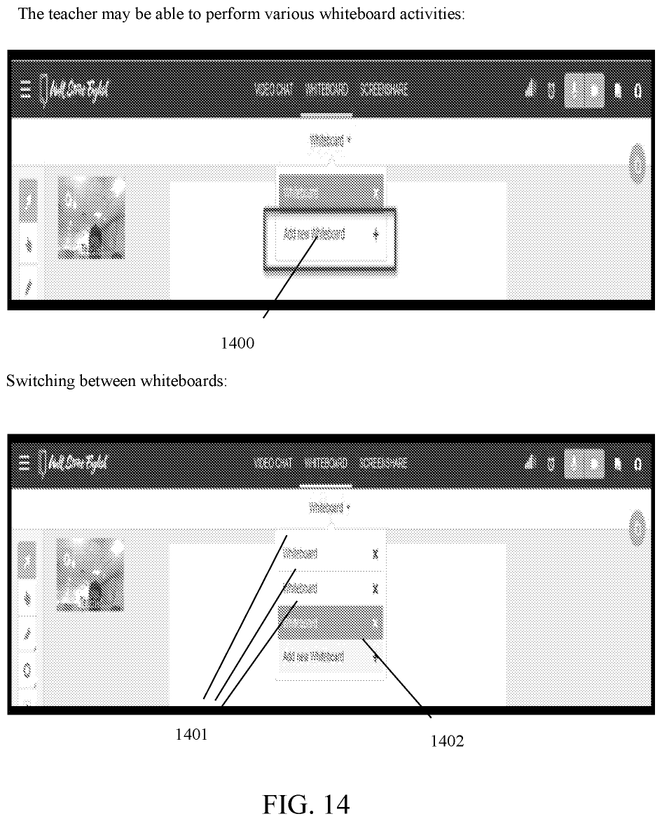

FIG. 14 is an example screenshot that may be used by the teacher to manage one or more whiteboards 1301. As non-limiting examples, the teacher may 1) open an existing whiteboard by selecting the whiteboard from the dropdown menu 1401, 2) close a whiteboard by selecting an “X” next to the whiteboard, 3) create a new whiteboard by selecting “Add new Whiteboard” from the dropdown menu 1400 and/or 4) switch between whiteboards by selecting a new current whiteboard 1301 from the dropdown menu 1402.

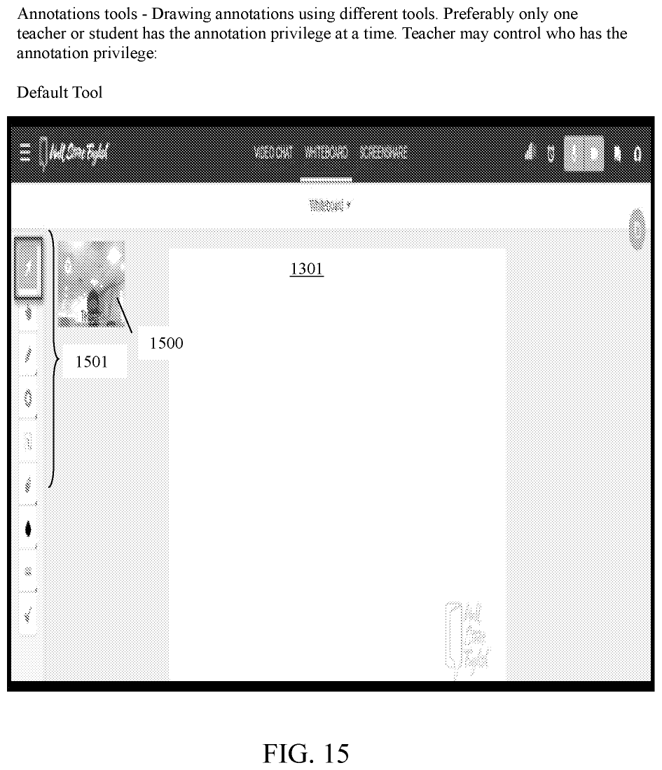

After the teacher has selected to enable a whiteboard 1301, FIG. 15 illustrates the whiteboard 1301 and the annotations tools 1501 that may be used to markup the whiteboard 1301. As non-limiting examples, the annotation tools 1501 may allow the user (teacher or student) to draw or create various shapes in various sizes and colors. The teacher or student that has control over the whiteboard 1301 preferably has their video tile 1500 displayed next to the annotation tools 1501.

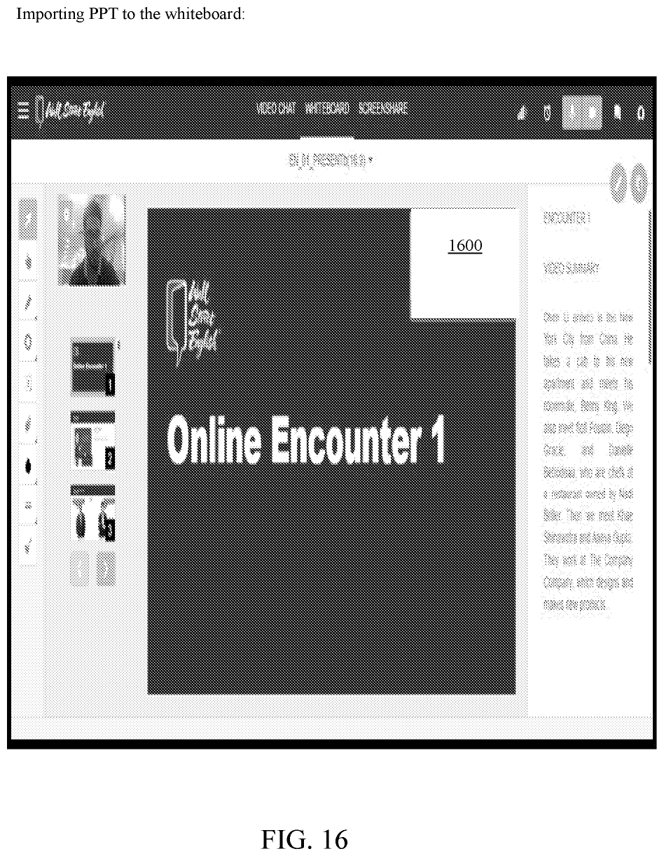

FIG. 16 is an example screenshot with a PPT presentation 1600 being imported to the whiteboard 1301. The teacher may upload a PPT file from the data store 110 by clicking on the ‘Import File’ button, selecting the PPT file and then clicking on the “Import” button. When the PPT file uploads from the data store 110, a ‘default tool’ may be selected to navigate through the PPT animations/slides. The PPT notes and thumbnails may also be loaded along with the PPT. The teacher may toggle the PPT notes ON/OFF, thereby controlling whether the students are able to see the notes on the whiteboard 1301 during the class.

The teacher may have several ways to navigate through the PPT deck. As an example, the teacher may select the default tool and click on the whiteboard 1301 to advance the animation. If the animation reaches the last point in the slide, the teacher may be navigated to the next slide. The teacher may directly select the slides from the thumbnails (by scrolling, if needed). The teacher may also click on the forward and backward navigational arrows. The teacher may annotate the PPT in the same manner as the teacher annotated the whiteboard 1301.

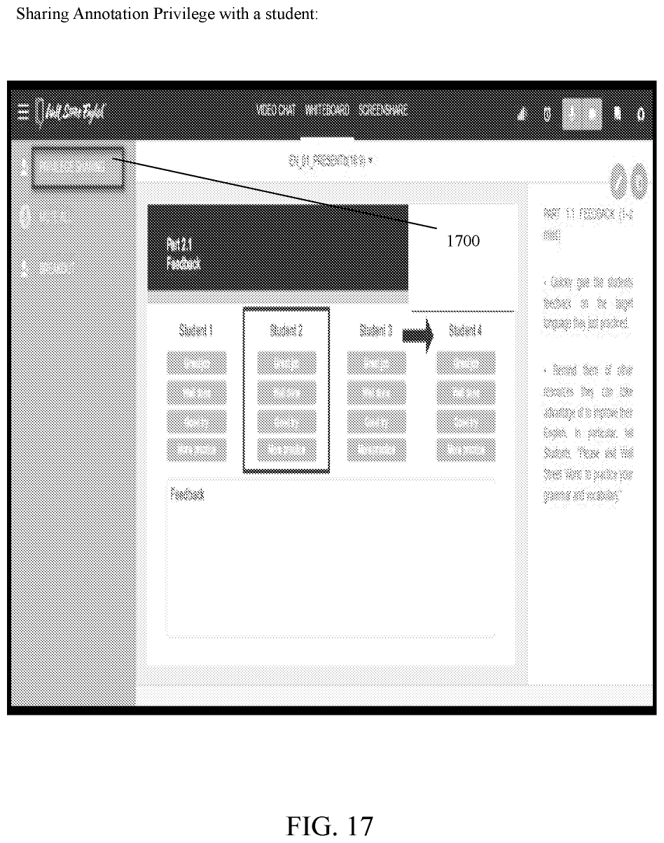

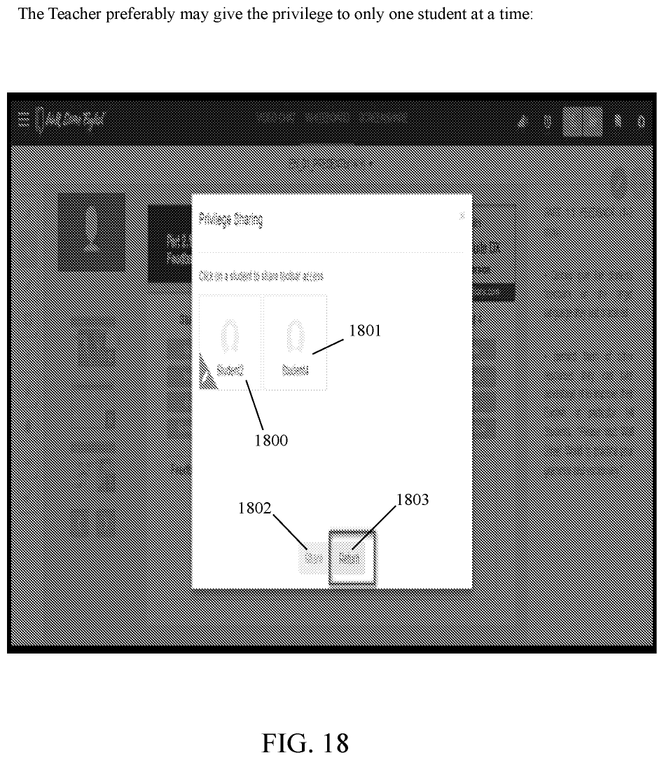

FIG. 17 is an example screenshot of a teacher sharing the annotation privileges with a student 1710. The teacher may select “PRIVILEGE SHARING” 1700 and, as shown in FIG. 18, select one of the displayed students 1800, 1801 to give the annotation privilege to the student. The teacher may have the ability to share the annotation privilege with the student by clicking on a privilege button 1700, selecting the student 1800, 1801 from the pop-up and clicking on the share button 1802. The teacher may thereafter take back the annotation privilege by clicking on the Return button 1803 or move the annotation privilege to another student. While the teacher may share the annotation privilege with any desired number of students, in a preferred embodiment, only one student at a time is allowed to have the annotation privilege.

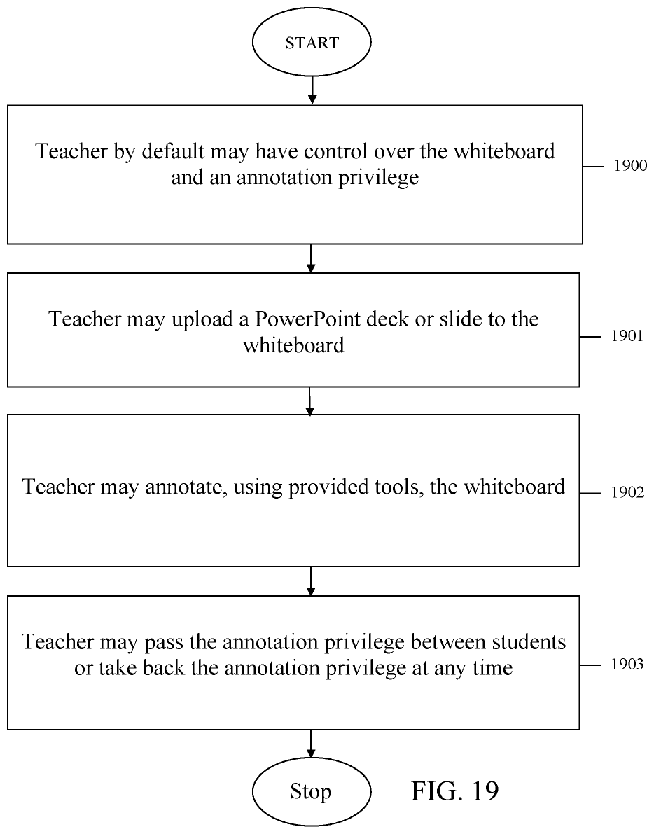

FIG. 19 is a non-limiting example of a flowchart illustrating a method for using a whiteboard as part of the invention. In this embodiment, the teacher may initially have control over the whiteboard and annotation privileges by default. (Step 1900) The teacher, while the teacher has control over the whiteboard may upload visual data to the whiteboard 1301, such as a slide from a PowerPoint deck of slides or any other visual medium in any other format. (Step 1901) The teacher may also annotate the whiteboard and/or the PPT slide, preferably using annotations tools provided to the user (teacher or student) that controls the whiteboard. (Step 1902) The teacher may pass the annotation privilege to or between students or take back the annotation privilege at any time. (Step 1903)

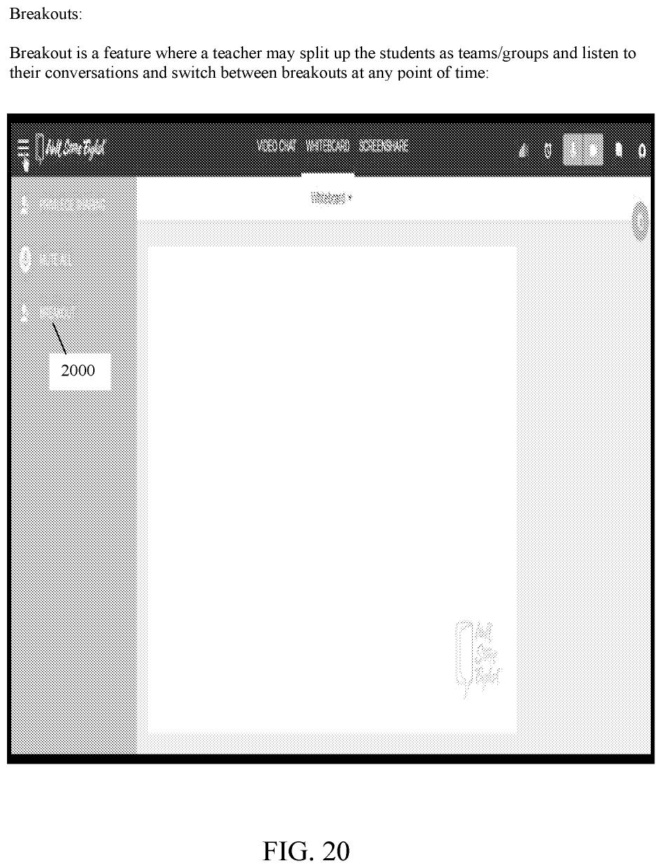

FIG. 20 illustrates an example screenshot that may be used by the teacher to initiate a breakout. In this example, the teacher is able to select the “BREAKOUT” option 2000 to start the process of creating a breakout session. A breakout, breakout session or breakout feature allows the teacher to break the students into two or more smaller groups, with each smaller group comprises at least two students and each group of students is placed into their own virtual breakout room for a period of time selected by the teacher. The students may then practice, work together and/or discuss one or more topics provided by the teacher in these smaller private groups.

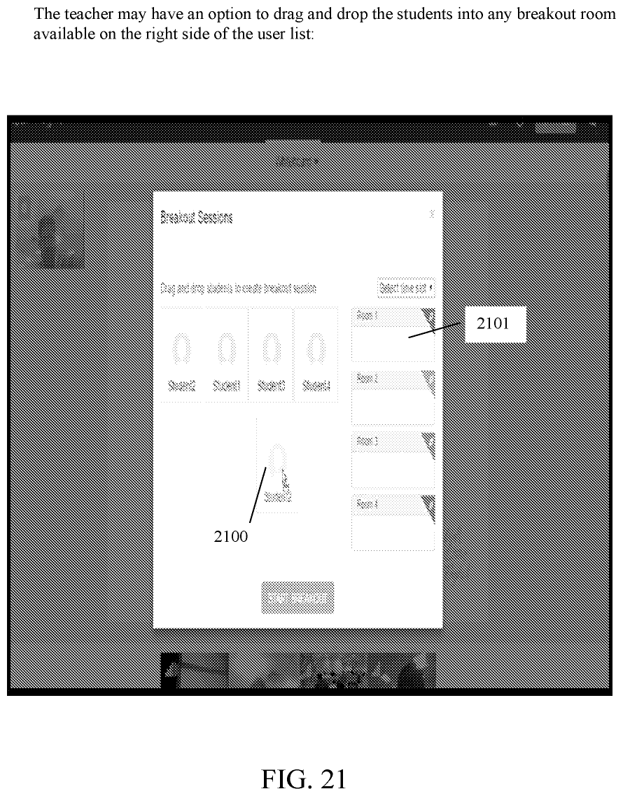

FIG. 21 illustrates an example screenshot that permits the teacher to create the breakout. While a breakout is active, students can only hear (and optionally only see) other students in their group. If the teacher is in the students' group, then the students in that group can hear (and optionally see) the teacher. The students and/or teacher that are in the same group and can hear each other are considered as being in the same breakout room 2101. The teacher may enter and move around to any group in any breakout room. In preferred embodiments, the teacher may move from breakout room to breakout room with no buffering or connection resets. This is highly advantageous as buffering and connection resets create breaks in the audio and video streams of the teacher and students which hurt the overall teacher and student experience in the class.

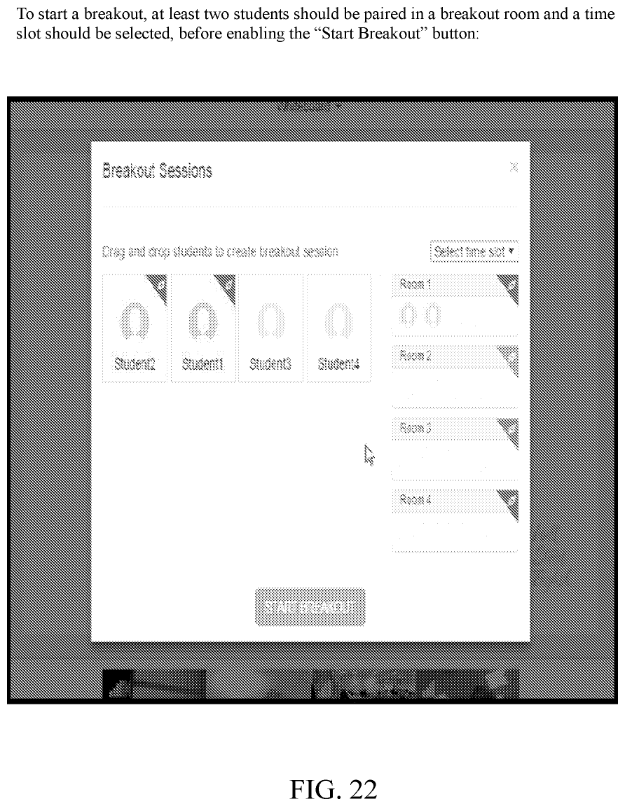

FIG. 22 illustrates an example of where the teacher has already dragged and dropped Student1 and Student2 into breakout room 1. In this example screenshot, the breakout rooms are illustrated to the right of the list of students. The screenshot also shows the student tiles displayed within the diagram on the screenshot representing breakout room 1, indicating Student1 and Student2 are within the same breakout room, i.e., breakout room 1.

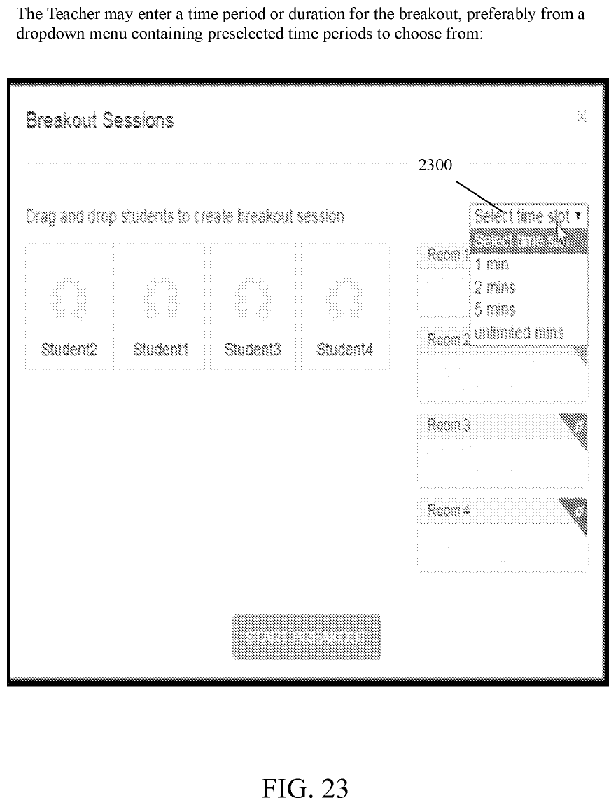

FIG. 23 illustrates an example screenshot configured to allow the teacher to select a breakout time from a dropdown menu 2300. To start a breakout, at least two students should be paired in a breakout room and a time slot should be selected. After the digital classroom detects at least two students paired in a room and a time slot selected by the teacher, the digital classroom may automatically enable the “Start Breakout” button as illustrated in FIG. 23.

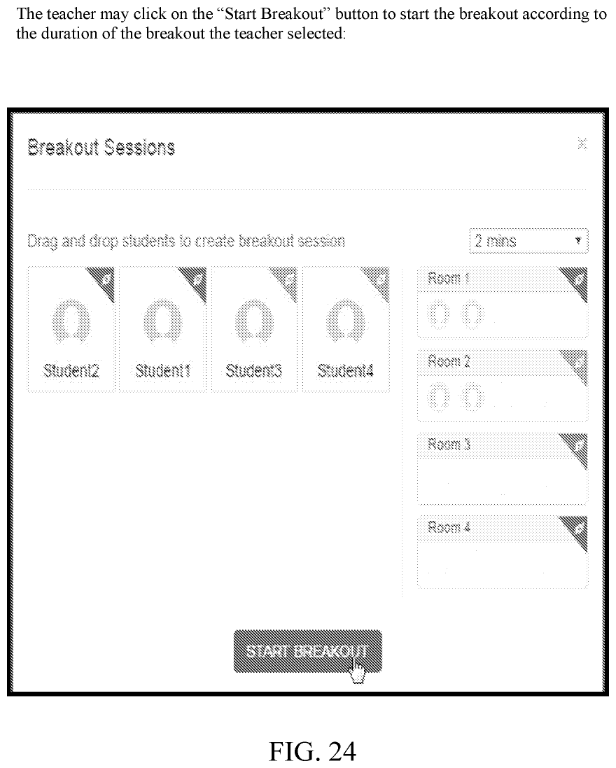

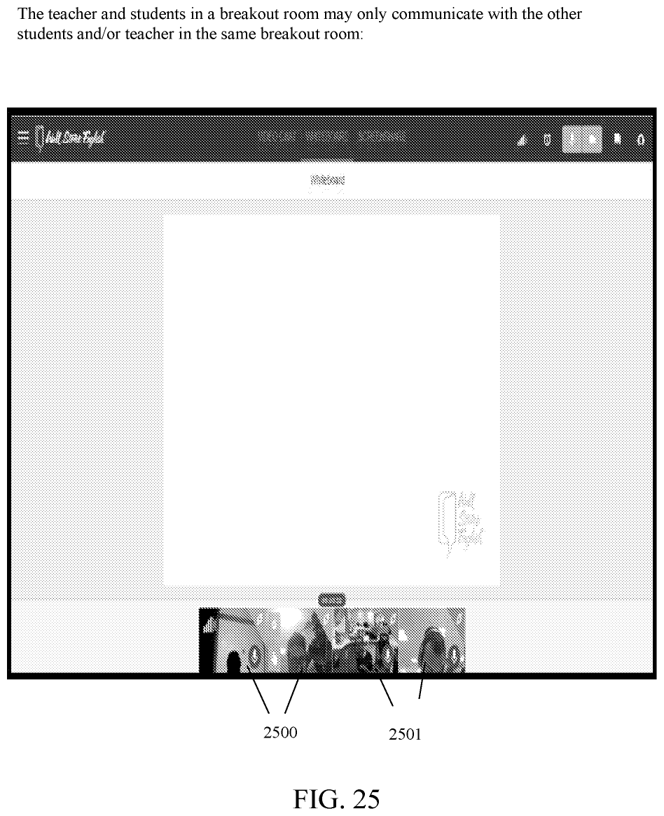

FIG. 24 illustrates the situation of Student1 and Student2 being grouped together in breakout room 1 and Student3 and Student4 being grouped together in breakout room 2. In addition, the teacher has selected a breakout time of 2 minutes. As at least two students are in a breakout room and a breakout time has been selected, the digital classroom may automatically enable the “START BREAKOUT” button. The teacher may click on the “Start Breakout” button to start the breakout for the duration of the time selected by the teacher. Once the breakout has started, the “Start Breakout” button may be turned to an “End Breakout” button, so that the teacher may end the breakout at any time within the breakout time frame. After the breakout has started, a user/student may determine whom the student is paired with by matching color or other presented indications on the participant panel, as shown in FIG. 25 at video tiles 2500 and 2501.

FIG. 25 illustrates a screenshot that may be displayed during the breakout. The students in the breakout may communicate (hear and speak) only with the students in the same breakout. Thus, in FIG. 25 students 2500 in one breakout room 2402 may only be able to hear each other and students 2501 in a second breakout room 2403 may only be able to hear each other. In some embodiments, all participants (teacher and students) may see all the other participants, but may communicate (hear and speak) only with the participants, i.e., teacher and/or students, in their own breakout room. By default, the teacher is preferably not in any of the breakout rooms at the start of the breakout. The teacher may start in a common room by default (students in breakout rooms cannot hear the teachers audio).

Once the breakout session starts, the teacher may enter any breakout room 2402, 2403 by clicking the appropriate video thumbnail in the participant panel. In order to rearrange the groups, the teacher may move any student to a new breakout room by, as an example selection mechanism, dragging and dropping the student into the new breakout room. During a breakout, preferably no room has only one student. Any single student in a room (possibly caused by another student losing their connection or logging off) may be automatically (without any action by the teacher) moved to a common room. Rooms should either be empty or have at least two students and preferably no breakout room has more than four students. Breakout session may automatically be ended once the timer stops. The teacher may also end the breakout session early based on the students' or teachers needs by selecting a terminate breakout session button.

In a preferred embodiment, the technical implementation details for the digital classroom may be achieved using the WebRTC technology. The WebRTC technology may be used to achieve the described audio/ video features. As a non-limiting example, in order to use this technology, OpenTok and its related software development kits (SDKs) may also be used. During a normal session, the teacher and the students may be in a common room or a breakout room. In the common room, the teacher and students can see each other when their Video is ON and will hear everyone in the class. However, during a breakout session, the students and teacher are isolated into different groups (different virtual breakout rooms) where the students and teacher can't hear and see the students in other rooms. The students can see and hear the teacher only when the teacher is in the students' common or breakout room.

The functionality of isolating the students' sound based on the rooms may be achieved through the WebRTC's audio muting Application Programming Interface (API) and certain logic to hide the users video streams for a specific period of time. This enables the digital classroom to get back to the normal session after the breakout is done (either by finishing with the teachers selected time or by the teacher terminating the breakout early) without closing the normal session and starting a new one. The students and teacher will be in the same classroom throughout the session time, but by disabling the audio and/or video the appearance of one or more virtual breakout rooms may be created.

The teacher may click on any of the users 2400, 2401 in a breakout room 2402, 2403 to join that particular breakout room. In some embodiments, the teacher may be able to select an option to speak to all the students, i.e., the students may all receive the teachers audio, even during a breakout. The user/student may be able to identify if the teacher is in his/her breakout room by observing the teacher's video. The teacher may be able to identify which breakout room the teacher is in by observing the color matching on the teachers own video tile. In this embodiment, if the teacher's video is not displayed for the breakout users, then the teacher would be in another breakout room or the common room. When the teacher joins any breakout room, the teacher may be able to hear the students' audio in that breakout room and can communicate with the users in that breakout room.

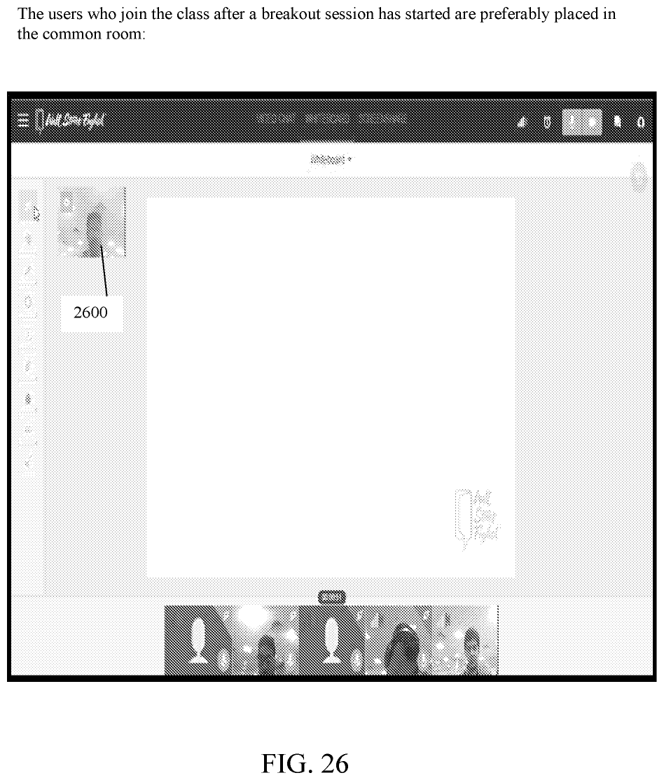

FIG. 26 illustrates a screenshot of the situation where a student 2600 has joined the class after the breakout has started. The student 2600 is preferably placed in the common room in this situation. The teacher may then click on one of the students in the common room to switch to the common room and can communicate with (receive the audio from) the student 2600 in the common room.

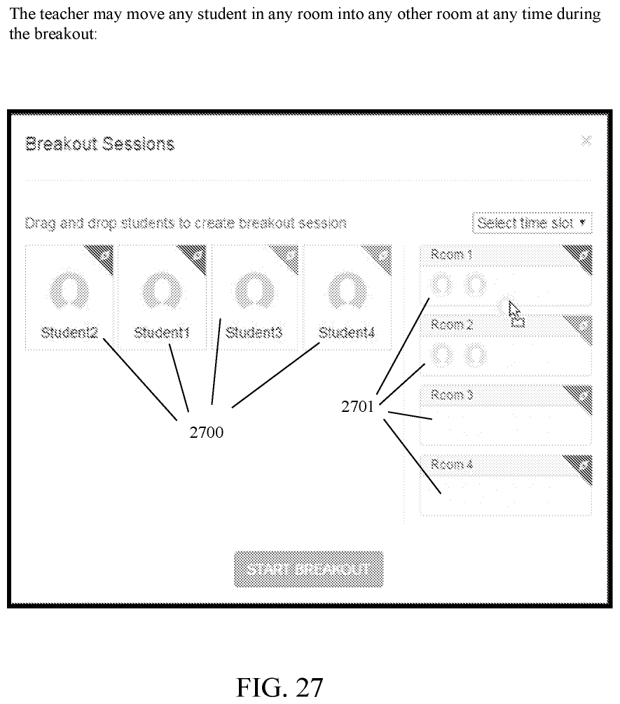

FIG. 27 illustrates a screenshot allowing the teacher to move any student (Student1, Student2, Student3 or Student4) into any other breakout room (room 1, room 2, room 3 or room 4) at any time during the breakout. Once inside the new breakout room, the moved student would only be able to communicate with the students/teacher in their new breakout room. In a preferred embodiment, all of the students/participants/teacher may observe where students are moved by visually detecting color changes or other provided indications on the teacher or student video tiles.

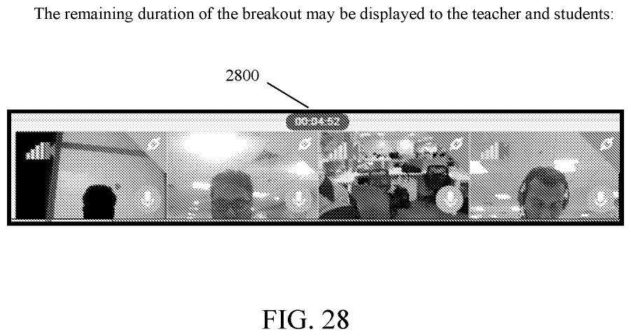

FIG. 28 illustrates a screenshot showing that the remaining time of the breakout may be displayed to the teacher and students. When the breakout is created with a time frame other than unlimited, a timer may be displayed and updated in real time with the remaining time left in the breakout.

Students may see which group the teacher is in by a marker (such as a color and/or an icon) placed on the teachers video or teacher tile. The teacher may move (preferably using a drag and drop mechanism) any student 2700 to any group (breakout room) 2701 at any time during the breakout. In a preferred embodiment, when the teacher moves a student, the teacher may have a brief 1-on-1 with the student to explain to the student why the student is being moved to a different breakout room.

In some embodiments, the teacher and students can only see the video tile of the teacher and/or students in their group, while in other embodiments, the teacher and students may always see each others video tile, regardless of which room the teacher and/or students are in. Students' and the teachers video tile may be color coded so that the teacher and students may see which students and/or teacher are in which groups. The students are preferably prevented by the digital classroom from moving themselves to a different group/breakout room 2701.

Each group during a breakout preferably has access to its own whiteboard and/or can see the teachers original or current whiteboard 1301. Students may have access to a hand-wave feature and/or chat to request teacher assistance. When the teacher notices use of the hand-wave feature or in response to a chat request from a student, the teacher may move to the group requesting assistance.

After the teachers selected length of time for the breakout is done, the breakout session may be terminated and all of the students and the teacher are preferably automatically (without affirmative action by the teacher) moved back into one group, i.e., the common room. Alternatively, the teacher may select an “End Breakout” button to stop the breakout before the end of the time selected by the teacher. In another option, the teacher may have an “add one minute” (or any other fixed or entered period of time) option to allow the breakout to go longer than originally scheduled. The teacher may save each students' session and/or breakout session as an attachment to a gradebook, wherein the gradebook is stored in a database, such as the data store 110.

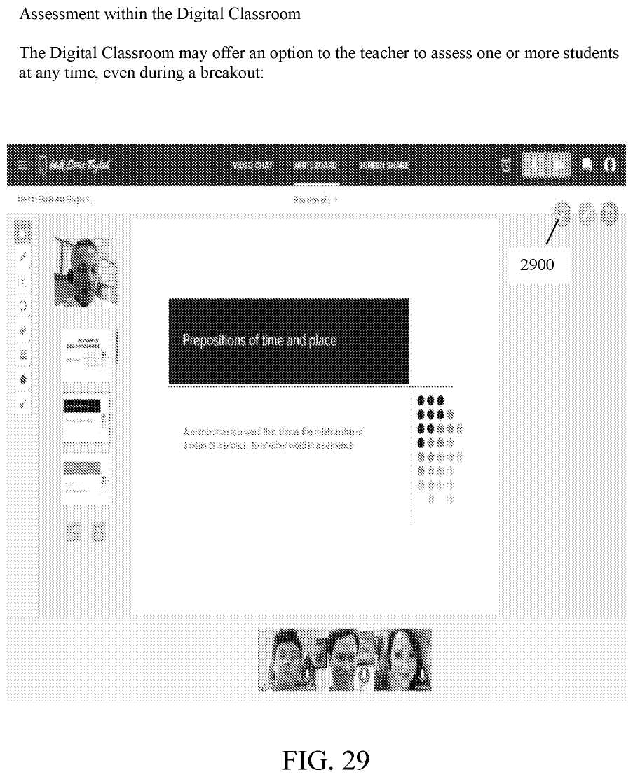

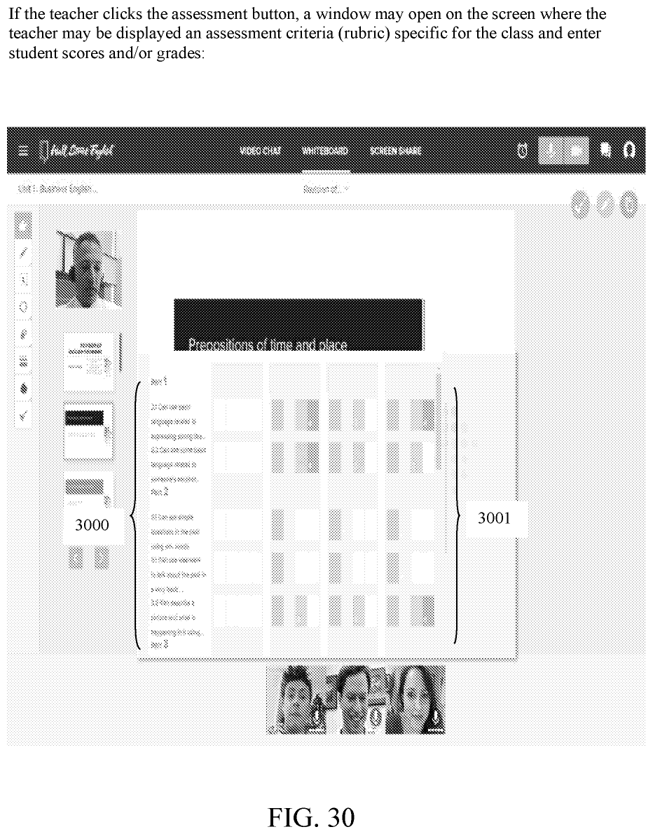

FIG. 29 illustrates a screenshot configured to allow the teacher to select a displayed icon 2900 to assess one or more students. Assessment of students may occur before, during and/or after a breakout. An assessment button 2900 may be displayed to the teacher for selection at any time during the class and even at any time during a breakout. Pressing the assessment button may trigger the display of the screenshot illustrated in FIG. 30.

FIG. 30 illustrates a displayed rubric 3000 on the teacher client device 106 which allows the teacher to enter a score for one or more evaluation topics in a displayed grading area 3001. In a preferred embodiment, the rubric 3000 is custom made for the current class being taught by the teacher and the scores/grades may be entered by the teacher using a touch screen on the teacher client device 106. The grades and/or scores entered on the teacher client device 106 may be stored in a data store 110 for later use and/or analysis.

In a preferred embodiment, the teacher may be able to assess any student during a breakout from the same screen that allows the teacher to move the teacher and students between breakout rooms. This allows the teacher to easily move themselves and the students between breakout rooms while substantially simultaneously assessing the students. In other words, the teacher may intermix moving and assessing the students in real time. This allows the teacher to assess the students while the students are in smaller groups where the teacher has a greater opportunity to hear each student speak.

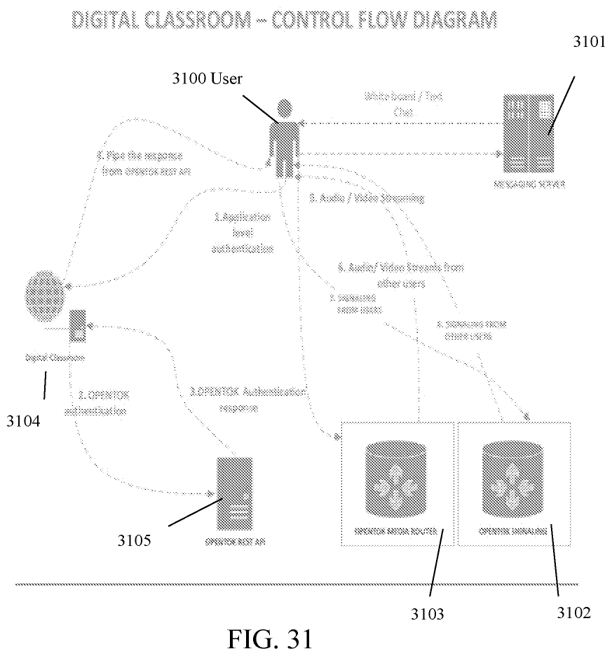

FIG. 31, illustrates an example control flow diagram for the digital classroom 3104. The user 3100 may perform an application level authentication with the digital classroom 3104 using, as a non-limiting example, an OpenTok authentication with an OpenTok Representational State Transfer (REST) API 3105. The OpenTok REST API 3105 may provide an OpenTok Authentication response back to the Digital Classroom 3104. The digital classroom 3104 may communicate the response from the OpenTok REST API back to the user 3100. The user 3100 may audio/video stream the data to an OpenTok Media Router 3103. The OpenTok Media Router may send the audio/video streams from the other users (teacher and students) to the user 3100. The user 3100 may send their signaling to the OpenTok Signaling 3102. The Opentok Signaling 3102 may transmit the signaling from the other users to the user 3100. The user 3100 may also communicate with a Messaging Server 3101 to see the whiteboard and text chat during the class.

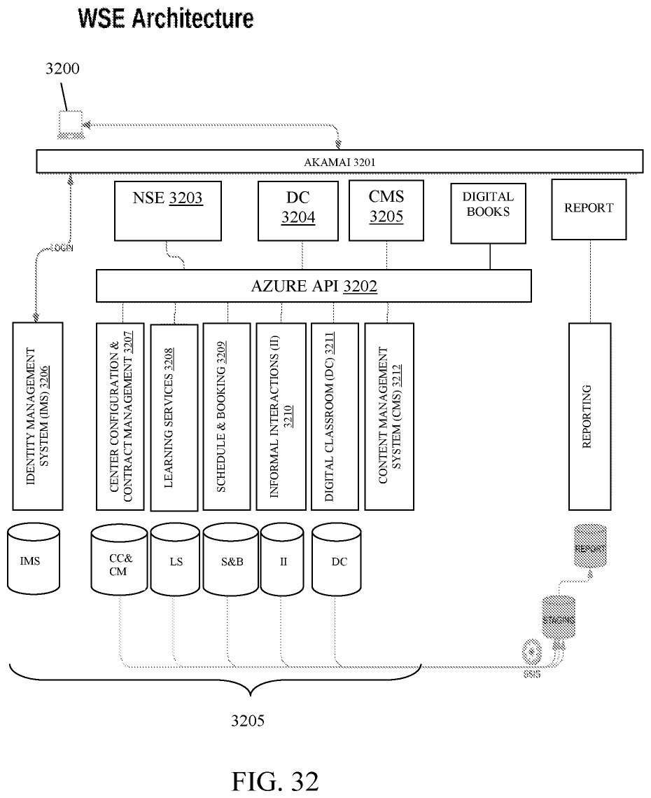

FIG. 32 illustrates an example computer architecture that may be used to practice the invention. The architecture includes a teacher client device 3200 or a student client device 3200 that communicates to the digital classroom 3211 over a content delivery network (CDN) 3201, such as that offered by Akamai™. The teacher and student client devices 3200 may be authenticated using any desired authentication method, such as that performed by an Identification Management System (IMS) 3206. Teachers and students may be authenticated by the IMS 3206 using any desired method. As a non-limiting example, a teacher or a student may be required to enter a login name and a password as part of an authentication process. In other embodiments, the teacher or student may be authenticated using a biometric of the teacher or student, such as a thumb print or a retinal scan. In other embodiments, the IMS 3206 may place a cookie on the teacher client device 3200 or the student client devices 3200 after authentication and then use the existence of the cookie in future authentication processes as a positive indicator of the teacher or student in the authentication process.

In addition, the digital classroom 3211 may communicate with various functions using an Application Programming Interface (API), such as that offered by the Microsoft Azure API™ 3202. As non-limiting examples, the architecture for the school may also include the functions or systems of a Center Configuration & Contract Management (CC&CM) 3207, Learning Services 3208, Schedule & Booking 3209, Informal Interaction 3210, Digital Classroom 3211 and a Content Management System (CMS) 3212.

The Center Configuration & Contract Management (CC&CM) 3207 system may be used to store data regarding a plurality of facilities (centers), provide an initial status of the facilities and to configure the facilities so as to be part of the school architecture hardware platform. Specifically, the CC&CM 3207 may store a country location for each facility, an address for each facility and classes that are offered by the facility. This data may be used by the CC&CM 3207 and other applications running on the school architecture in configuring and performing the operations of the digital classroom. The CC&CM 3207 may also store data regarding the students that have registered for classes with the digital classroom. The CC&CM 3207 may store the contracts for its students, personal information of the students and desired areas of study for each student.

The Learning Services (LS) 3208 function may be used by the students to enhance the student's learning while not specifically attending a digital class. As non-limiting examples, the LS 3208 may provide an ability for the students to watch educational videos appropriate to the skill level of the student and to do homework that will prepare the student for the student's next digital class.

The Schedule & Booking (SB) 3209 function may be used by school administrators to schedule classes and by students to book the scheduled classes as previously described.

The Informal Interactions (II) 3210 function may be used by the students to enhance their formal educational experiences with informal interactions. The Informal Interactions 3210 function may store information regarding social events, teachers' availability outside of class or practice sessions outside of class and provide this information to the students upon request. This allows the students to meet and work with each other in an informal setting with less pressure to practice the material being taught by the digital classroom 3211.

The Content Management System (CMS) 3212 may be used to create, store, manage and transmit digital content for the digital classroom 3211. The CMS 3212 may be used by the teachers, students and school administration in processing and exchanging information within the school's collaborative environment. The CMS 3212 may receive, as non-limiting examples, classroom content material, scoring rubrics and PowerPoint Presentations (PPT), store the information in a data store 110 and then transmit the information to the teacher and student client devices 106 in conjunction with a class offered by the digital classroom 3211.

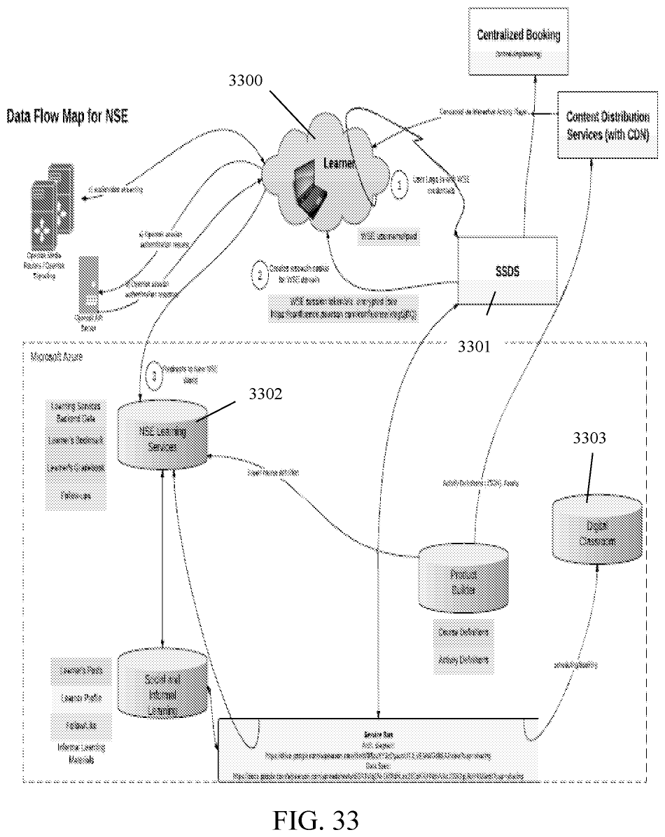

FIG. 33 is an example of a possible data flow for a new student experience (NSE). In this example, the Learner 3300 (student), using a student client device 106 previously described, may log into the system via the SQL Server Data Service (SSDS) 3301 using the Learners credentials. The Learners credentials may be a username and password or the credentials may comprise a biometric feature of the Learner, such as a fingerprint. The SSDS 3301 may create a cookie for a domain name registered to the online school to create a hyperlink that allows the Learner 3300 (and hyperlinks for the teacher and other students) to access the class just prior to, for example 10 minutes before, the start of the class. The Learner 3300 may use the created hyperlink to be directed to the NSE Learning Services 3302. The NSE Learning Services 3302 may operate on any desired platform, but in FIG. 33 is shown running on Microsoft Azure™. The Learner 3300 may then participate in the class controlled by the digital classroom 3303 as previously described.

FIG. 34 illustrates a flow of data (digital classroom material) used by the teachers and students in one or more classes. An Administrator 3400 working for the school or digital classroom 3403, using an administrator client device 106, may enter the digital classroom material into a Content Management System 3212. While some of the digital classroom material may be general and used by a plurality of classes, most of the digital classroom material may be specifically created for a particular class offered by the digital classroom 3403. The digital classroom material may be stored in a data store 110. The stored digital classroom material may be updated from time to time by the Administrator 3400 as desired. The stored digital classroom material may be repeatedly used for any number of different classes offered and taught by the digital classroom 3403. The digital classroom 3403 may access the data store 110 to retrieve the data (digital classroom material) specific for a pending class via a computer network, Internet and/or a content delivery network, such as that offered by Akamai™ 3402. The digital classroom 3403, as illustrated in FIG. 34, may operate using any desired platform or operating system, such as a web platform or an iOS and/or android operating system.

The Administrator 3400, using a client device 106, may also upload materials, typically files, into a Content Management System 3212 that may also be used as part of a class offered by the digital classroom 3403. While any type or format of electronic materials may be used, in preferred embodiments, the files are PowerPoint (PPT) files. These files may also be stored in a data store 110 and/or managed by a distribution service on the Content Management System 3212, such as that offered by iSpring. The digital classroom 3403 may access the Content Management System 3212 to retrieve the uploaded material for a pending class via a computer network, Internet and/or a content delivery network, such as that offered by Akamai 3402.

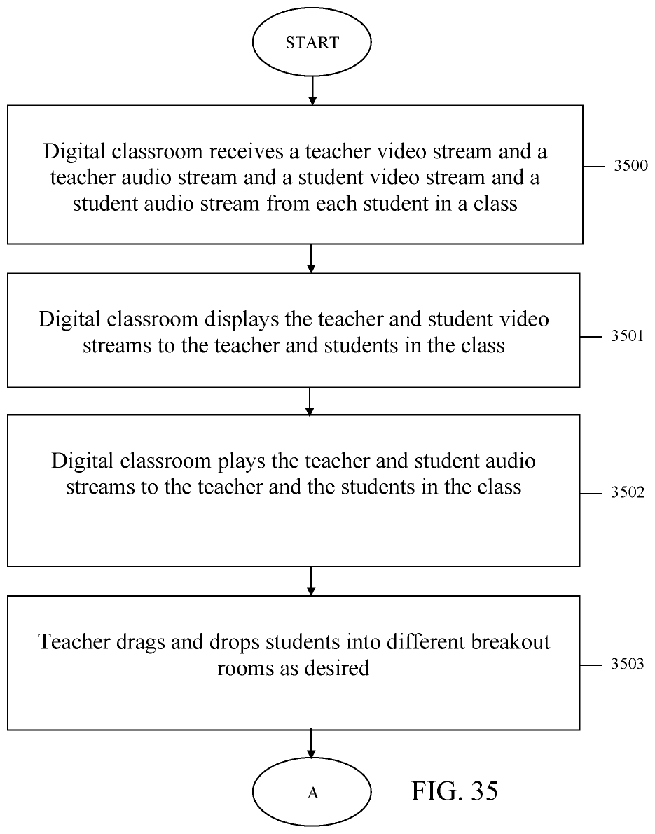

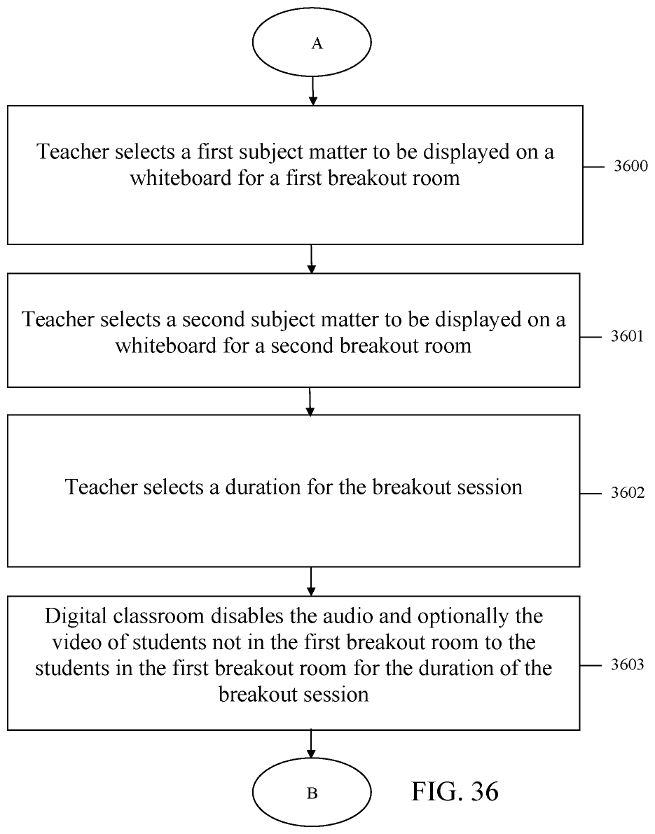

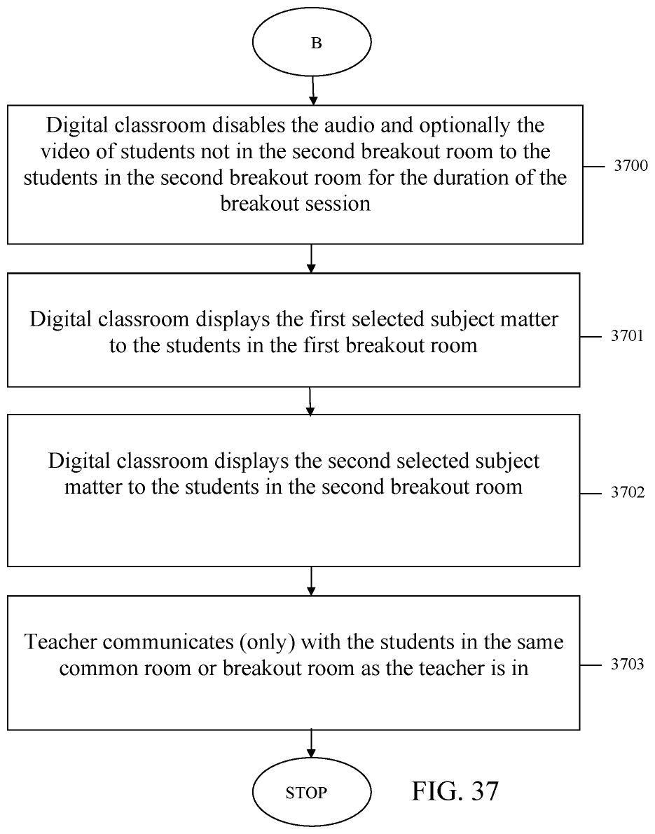

FIGS. 35-37 illustrate a flowchart of another non-limiting method of practicing the invention, in which a digital classroom 3403 is used to teach a plurality of students a subject in a class. The subject may be any desired subject, such history, marketing, mathematics, science, business, art or a language, such as English.

The digital classroom 3403 may receive over the Internet a teacher video stream and a teacher audio stream from a teacher client device operated by a teacher. The digital classroom 3403 may also receive a student video stream and a student audio stream from each student client device in a plurality of student client devices operated by a student in a plurality of students taking the class. (Step 3500) In this manner, the digital classroom 3403 has the video and audio stream of all of the users or participants (teacher and students taking the class) in the class.

The digital classroom 3403 may display on the teacher client device 106 and the plurality of student client devices 106 the teacher video stream in a teacher tile. The digital classroom 3403 may also display the student video stream in a student tile for each student in the plurality of students taking the class. (Step 3501) In this manner, the teacher and students in the class may see in a video stream of the teacher and a video stream of the students in real-time as the class proceeds.

The digital classroom 3403 may communicate to the teacher client device 106 and the plurality of student client devices 106 the teacher audio stream from the teacher and the student audio stream from each student in the plurality of students. In this manner, the teacher and students in the class may hear in an audio stream the teacher and the students in real-time as the class proceeds. In some embodiments, the teacher audio stream is not sent to the teacher client device 106 and each student audio stream is not sent to the student client device 106 creating the student audio stream to prevent feedback. (Step 3502

The digital classroom 3403 may receive from the teacher client device a selection of a first two or more students in the plurality of students for a breakout in a first breakout room. The digital classroom 3403 may also receive from the teacher a second two or more students in the plurality of students for the breakout in a second breakout room. Preferably, no student in the plurality of students is in more than one breakout room. (Step 3503) In preferred embodiments, the teacher is able to drag and drop a student tile or a student icon to an icon representing a breakout room, indicating to the digital classroom 3403 that the teacher wants to move the dragged and dropped student to a particular breakout room.

The digital classroom 3403 may receive a first selected subject matter from the teacher client device 106 for the first breakout room and a second selected subject matter, different from the first selected subject matter, from the teacher client device 106 for the second breakout room. (Steps 3600 and 3601) This allows the teacher to select different subject matter to be studied in different virtual breakout rooms.

The digital classroom 3403 may receive from the teacher client device 106 a selected duration of the breakout. The time may be typed into a field created for this purpose or the time may be selected from a dropdown menu of preselected time periods. (Step 3602)

The digital classroom 3403 may disable the student audio stream of every student in the plurality of students not in the first breakout room to the first two or more students in the first breakout room for the duration of the breakout. This makes it so the students in the first breakout room can only hear other students also in the first breakout room for the duration of the breakout (unless moved by the teacher). (Step 3603)

The digital classroom 3403 may disable the student audio stream of every student in the plurality of students not in the second breakout room to the second two or more students in the second breakout room for the duration of the breakout. This makes it so the students in the second breakout room can only hear other students also in the second breakout room for the duration of the breakout (unless moved by the teacher). (Step 3700)

The digital classroom 3403 may display the first selected subject matter on the student client device 106 of the two or more students in the first breakout room, possibly on a virtual whiteboard 1301 for the first breakout room. (Step 3701)

The digital classroom 3403 may display the second selected subject matter on the student client device 106 of the two or more students in the second breakout room, possibly on a virtual whiteboard 1301 for the second breakout room. (Step 3702)

While the teacher is in the first breakout room, the digital classroom 3403 may communicate assessment criteria for a plurality of test areas to the teacher client device 106. The digital classroom 3403 may receive an assessment score for each test area in the plurality of test areas for one or more students in the first two or more students in the first breakout room. (Step 3703) The assessment scores entered by the teacher may be stored in a gradebook stored in a data store 110 on a Content Management System 3212. In addition, a video and/or audio recording of the entire class or of the breakout sessions may be stored in a data store 110, for future analysis or reference. Individual activity scores may be linked to a specific learning objective, thereby providing a holistic view of the student's performance in that learning objective. At the end of the class, the individual activity scores may be analyzed in order to provide the teacher with a probability percentage that the student is ready to proceed to the next unit.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method for using a digital classroom to teach a plurality of students, comprising the steps of:
receiving by the digital classroom over the Internet:
i) a teacher video stream and a teacher audio stream from a teacher client device operated by a teacher, and
ii) a student video stream and a student audio stream from each student client device in a plurality of student client devices operated by a student in a plurality of students;
displaying by the digital classroom on the teacher client device and the plurality of student client devices:
i) the teacher video stream in a teacher tile, and
ii) the student video stream in a student tile for each student in the plurality of students;
communicating by the digital classroom to the teacher client device and the plurality of student client devices:
i) the teacher audio stream from the teacher, and
ii) the student audio stream from each student in the plurality of students, except the teacher audio stream is not sent to the teacher client device and each student audio stream is not sent to the student client device creating the student audio stream;
receiving by the digital classroom from the teacher client device a selection of:
i) a first two or more students in the plurality of students for a breakout in a first breakout room, and
ii) a second two or more students in the plurality of students for the breakout in a second breakout room, wherein no student in the plurality of students is in more than one breakout room;
receiving by the digital classroom from the teacher client device a selected duration of the breakout;
disabling by the digital classroom the student audio stream of every student in the plurality of students not in the first breakout room to the first two or more students in the first breakout room for the duration of the breakout; and
disabling by the digital classroom the student audio stream of every student in the plurality of students not in the second breakout room to the second two or more students in the second breakout room for the duration of the breakout.

2. The method of claim 1, further comprising the steps of:
during the selected duration of the breakout, receiving by the digital classroom from the teacher client device a selection of the teacher for the first breakout room; and
triggered by receiving the selection of the teacher for the breakout room, disabling by the digital classroom the teacher audio stream to every student in the plurality of students not in the first breakout room for a remaining duration of the breakout.

3. The method of claim 1, wherein the selection of the first two or more students comprises a selection mechanism of dragging and dropping corresponding two or more student tiles or two or more student icons onto an icon for the first breakout room displayed on the teacher client devise.

4. The method of claim 1, further comprising the step of:
disabling by the digital classroom the teacher audio stream to every student client device for every student in the plurality of students not in the same breakout room as the teacher.

5. The method of claim 1, further comprising the steps of:
displaying by the digital classroom a first colored icon on the student tile of every student and/or the teacher tile for every teacher in the first breakout room; and
displaying by the digital classroom a second colored icon, visually distinguishable from the first colored icon, on the student tile of every student and/or the teacher tile for every teacher in the second breakout room.

6. The method of claim 1, further comprising the steps of:
displaying by the digital classroom a real-time count down of the time remaining for the breakout to the teacher client device and the student client device for every student in the plurality of students; and
triggered by an end of the time remaining for the breakout and without further action by the teacher or any student in the plurality of students, communicating by the digital classroom to the teacher client device and the plurality of student client devices:
i) the teacher audio stream from the teacher, and
ii) the student audio stream from each student in the plurality of students.

7. The method of claim 1, further comprising the steps of:
disabling by the digital classroom the student video stream of every student in the plurality of students not in the first breakout room to the first two or more students in the first breakout room for the duration of the breakout; and
disabling by the digital classroom the student video stream of every student in the plurality of students not in the second breakout room to the second two or more students in the second breakout room for the duration of the breakout.

8. A method for using a digital classroom to teach a plurality of students, comprising the steps of:
receiving by the digital classroom over the Internet:
i) a teacher video stream and a teacher audio stream from a teacher client device operated by a teacher, and
ii) a student video stream and a student audio stream from each student client device in a plurality of student client devices operated by a student in a plurality of students;
displaying by the digital classroom on the teacher client device and the plurality of student client devices:
i) the teacher video stream in a teacher tile, and
ii) the student video stream in a student tile for each student in the plurality of students;
communicating by the digital classroom to the teacher client device and the plurality of student client devices:
i) the teacher audio stream from the teacher, and
ii) the student audio stream from each student in the plurality of students, except the teacher audio stream is not sent to the teacher client device and each student audio stream is not sent to the student client device creating the student audio stream;
receiving by the digital classroom from the teacher client device a selection of:
i) a first two or more students in the plurality of students for a breakout in a first breakout room, and
ii) a second two or more students in the plurality of students for the breakout in a second breakout room, wherein no student in the plurality of students is in more than one breakout room;
receiving by the digital classroom a first selected subject matter from the teacher client device for the first breakout room;
receiving by the digital classroom a second selected subject matter, different from the first selected subject matter, from the teacher client device for the second breakout room;
receiving by the digital classroom from the teacher client device a selected duration of the breakout;
disabling by the digital classroom the student audio stream of every student in the plurality of students not in the first breakout room to the first two or more students in the first breakout room for the duration of the breakout;
disabling by the digital classroom the student audio stream of every student in the plurality of students not in the second breakout room to the second two or more students in the second breakout room for the duration of the breakout;
displaying by the digital classroom the first selected subject matter on the student client device of the two or more students in the first breakout room; and
displaying by the digital classroom the second selected subject matter on the student client device of the two or more students in the second breakout room.

9. The method of claim 8, further comprising the steps of:
during the selected duration of the breakout, receiving by the digital classroom from the teacher client device a selection of the teacher for the first breakout room; and
triggered by receiving the selection of the teacher for the breakout room, disabling by the digital classroom the teacher audio stream to every student in the plurality of students not in the first breakout room for a remaining duration of the breakout.

10. The method of claim 8, wherein the selection of the first two or more students comprises a selection mechanism of dragging and dropping corresponding two or more student tiles or two or more student icons onto an icon for the first breakout room displayed on the teacher client devise.

11. The method of claim 8, further comprising the step of:
disabling by the digital classroom the teacher audio stream to every student client device for every student in the plurality of students not in the same breakout room as the teacher.

12. The method of claim 8, further comprising the steps of:
displaying by the digital classroom a first colored icon on the student tile of every student and/or the teacher tile for every teacher in the first breakout room; and
displaying by the digital classroom a second colored icon, visually distinguishable from the first colored icon, on the student tile of every student and/or the teacher tile for every teacher in the second breakout room.

13. The method of claim 8, further comprising the steps of:
displaying by the digital classroom a real-time count down of the time remaining for the breakout to the teacher client device and the student client device for every student in the plurality of students; and
triggered by an end of the time remaining for the breakout and without further action by the teacher or any student in the plurality of students, communicating by the digital classroom to the teacher client device and the plurality of student client devices:
i) the teacher audio stream from the teacher, and
ii) the student audio stream from each student in the plurality of students.

14. The method of claim 8, further comprising the steps of:
disabling by the digital classroom the student video stream of every student in the plurality of students not in the first breakout room to the first two or more students in the first breakout room for the duration of the breakout; and
disabling by the digital classroom the student video stream of every student in the plurality of students not in the second breakout room to the second two or more students in the second breakout room for the duration of the breakout.

15. A method for using a digital classroom to teach a plurality of students, comprising the steps of:
receiving by the digital classroom over the Internet:
i) a teacher video stream and a teacher audio stream from a teacher client device operated by a teacher, and
ii) a student video stream and a student audio stream from each student client device in a plurality of student client devices operated by a student in a plurality of students;
displaying by the digital classroom on the teacher client device and the plurality of student client devices:
i) the teacher video stream in a teacher tile, and
ii) the student video stream in a student tile for each student in the plurality of students;
communicating by the digital classroom to the teacher client device and the plurality of student client devices:
i) the teacher audio stream from the teacher, and
ii) the student audio stream from each student in the plurality of students, except the teacher audio stream is not sent to the teacher client device and each student audio stream is not sent to the student client device creating the student audio stream;
receiving by the digital classroom from the teacher client device a selection of:
i) a first two or more students in the plurality of students for a breakout in a first breakout room, and
ii) a second two or more students in the plurality of students for the breakout in a second breakout room, wherein no student in the plurality of students is in more than one breakout room;
receiving by the digital classroom from the teacher client device a selected duration of the breakout;
disabling by the digital classroom the student audio stream of every student in the plurality of students not in the first breakout room to the first two or more students in the first breakout room for the duration of the breakout;
disabling by the digital classroom the student audio stream of every student in the plurality of students not in the second breakout room to the second two or more students in the second breakout room for the duration of the breakout;
disabling by the digital classroom the student video stream of every student in the plurality of students not in the first breakout room to the first two or more students in the first breakout room for the duration of the breakout;
disabling by the digital classroom the student video stream of every student in the plurality of students not in the second breakout room to the second two or more students in the second breakout room for the duration of the breakout;
during the selected duration of the breakout, receiving by the digital classroom from the teacher client device a selection of the teacher for the first breakout room;
triggered by receiving the selection of the teacher for the breakout room, disabling by the digital classroom the teacher audio stream to every student in the plurality of students not in the first breakout room for a remaining duration of the breakout; and
while the teacher is in the first breakout room:
i) communicating by the digital classroom assessment criteria for a plurality of test areas to the teacher client device, and
ii) receiving by the digital classroom an assessment score for each test area in the plurality of test areas for one or more students in the first two or more students in the first breakout room.

16. The method of claim 15, wherein the selection of the first two or more students comprises a selection mechanism of dragging and dropping corresponding two or more student tiles or two or more student icons onto an icon for the first breakout room displayed on the teacher client devise.

17. The method of claim 15, further comprising the step of:
disabling by the digital classroom the teacher audio stream to every student client device for every student in the plurality of students not in the same breakout room as the teacher.

18. The method of claim 15, further comprising the steps of:
displaying by the digital classroom a first colored icon on the student tile of every student and/or the teacher tile for every teacher in the first breakout room; and
displaying by the digital classroom a second colored icon, visually distinguishable from the first colored icon, on the student tile of every student and/or the teacher tile for every teacher in the second breakout room.

19. The method of claim 15, further comprising the steps of:
displaying by the digital classroom a real-time count down of the time remaining for the breakout to the teacher client device and the student client device for every student in the plurality of students; and
triggered by an end of the time remaining for the breakout and without further action by the teacher or any student in the plurality of students, communicating by the digital classroom to the teacher client device and the plurality of student client devices:
i) the teacher audio stream from the teacher, and
ii) the student audio stream from each student in the plurality of students.

20. The method of claim 15, further comprising the steps of:
storing by the digital classroom the student audio stream from each student in the plurality of students during the breakout into a gradebook stored in a database.

21. A method for an online school to use a digital classroom to teach a plurality of students, comprising the steps of:
scheduling, by a school administrator, a class from a scheduling dashboard displayed on an administrator client device, wherein the scheduling dashboard comprises a table, each teacher in a plurality of teachers comprise a column in the table and each hour in a day comprises a row in the table;
transmitting the scheduling dashboard to the administrator client device, wherein the scheduled class is displayed on the scheduling dashboard;
transmitting a teacher dashboard to a teacher client device of a teacher, wherein the scheduled class is displayed on the teacher dashboard;
transmitting a booking dashboard to a plurality of student client devices of a plurality of students, wherein the scheduled class is displayed on the booking dashboard for each student;
receiving by the online school a booking request for the class by each student client device in the plurality of student client devices;
generating, by the online school, the digital classroom accessible via the Internet by the teacher client device and the plurality of student client devices;
authenticating an identity of the teacher and the plurality of students;
receiving by the digital classroom over the Internet:
i) a teacher video stream and a teacher audio stream from the teacher client device operated by the teacher, and
ii) a student video stream and a student audio stream from each student client device in the plurality of student client devices operated by a student in a plurality of students;
displaying by the digital classroom on the teacher client device and the plurality of student client devices:
i) the teacher video stream in a teacher tile, and
ii) the student video stream in a student tile for each student in the plurality of students;
communicating by the digital classroom to the teacher client device and the plurality of student client devices:
i) the teacher audio stream from the teacher, and
ii) the student audio stream from each student in the plurality of students, except the teacher audio stream is not sent to the teacher client device and each student audio stream is not sent to the student client device creating the student audio stream;
receiving by the digital classroom from the teacher client device a selection of:
i) a first two or more students in the plurality of students for a breakout in a first breakout room, and
ii) a second two or more students in the plurality of students for the breakout in a second breakout room, wherein no student in the plurality of students is in more than one breakout room;
receiving by the digital classroom from the teacher client device a selected duration of the breakout;
disabling by the digital classroom the student audio stream of every student in the plurality of students not in the first breakout room to the first two or more students in the first breakout room for the duration of the breakout; and
disabling by the digital classroom the student audio stream of every student in the plurality of students not in the second breakout room to the second two or more students in the second breakout room for the duration of the breakout.

22. An online school platform, comprising:
a scheduling and booking system comprising one or more hardware servers:
i) in electronic communication with an administrator client device, configured to transmit a scheduling dashboard to the administrator client device and receive a class scheduled on the scheduling dashboard from the administrator client device,
ii) in electronic communication with a teacher client device operated by a teacher, configured to transmit a teacher dashboard to the teacher client device indicating the class scheduled for the teacher and
iii) in electronic communication with a plurality of student client devices operated by a corresponding plurality of students, configured to transmit a booking dashboard to the student client devices indicating an availability of the class and receive a booking request from each of the plurality of student client devices;
a learning services system comprising one or more hardware servers in electronic communication with the plurality of student client devices, configured to transmit and display educational videos and homework assignments to the student client devices;
an informal interaction system comprising one or more hardware servers in electronic communication with the teacher client device and the plurality of student client devices, configured to assist the plurality of students to engage in social activities and informal group interactions;
a content management system comprising one or more hardware servers in electronic communication with a content creator client device, the teacher client device and the student client devices, configured to receive course content from the content creator client device and deliver the course content to the teacher client device and the student client devices;
an identity management system comprising one or more hardware servers in electronic communication with the teacher client device and student client devices, configured to authenticate the identity of the teacher and the identity of each student in the plurality of students; and
a digital classroom comprising one or more hardware servers in electronic communication with the teacher client device and the plurality of student client devices, configured to:
i) receive an audio stream and a video stream from the teacher client device and an audio stream and a video stream from each of the plurality of student client devices,
ii) at a first time, generate a common room, where the teacher client device and the plurality of student client devices receive the audio stream from the other student client devices and
iii) at a second time, different from the first time, generate a plurality of virtual online breakout rooms, wherein each student client device in the plurality of student client devices receives an audio stream from every teacher client device and student client devices in the same virtual online breakout room, but does not receive an audio stream from every teacher client device and student client devices not in the same virtual online breakout room.
